(19) United States
(12) Patent Application Publication
(10) Pub. No.: US 2025/0083326 A1
(43) Pub. Date: Mar. 13, 2025

(54) END EFFECTOR, ROBOT SYSTEM, CONTROL METHOD OF END EFFECTOR, CONTROL METHOD OF ROBOT SYSTEM, MANUFACTURING METHOD OF ARTICLE, AND COMPUTER READABLE MEDIUM

(71) Applicant: CANON KABUSHIKI KAISHA, Tokyo (JP)

(72) Inventors: HIDETADA ASANO, Tokyo (JP); ISAMU OKUMA, Tokyo (JP); RYOTA OKAZAKI, Kanagawa (JP); RYOJI TSUKAMOTO, Kanagawa (JP); HIROTO MIZOHANA, Tokyo (JP)

(21) Appl. No.: 18/820,592

(22) Filed: Aug. 30, 2024

(30) Foreign Application Priority Data
Sep. 8, 2023 (JP) 2023-145971

(51) Int. Cl. B25J 9/16; B25J 13/08

(52) U.S. Cl. CPC B25J 9/1697; B25J 13/089

(57) ABSTRACT

An end effector includes a base portion, an imaging apparatus supported by the base portion, and a tool movably supported by the base portion, the tool being configured to support a workpiece and perform work with respect to the workpiece. The base portion includes a driving mechanism. In a case of capturing an image of an imaging object by the imaging apparatus, the driving mechanism is configured to position the tool supporting the workpiece outside of a range in which at least part of the tool or the workpiece supported by the tool overlaps with the imaging object in a field of view of the imaging apparatus.

### BACKGROUND OF THE INVENTION

### Field of the Invention

This disclosure relates to an end effector, a robot system, a control method of the end effector, a control method of the robot system, and a manufacturing method of an article, and a computer readable medium.

### Description of the Related Art

For example, gripping a workpiece with a finger of a robot hand and installing the workpiece at a desired position are disclosed (refer to Japanese Patent Laid-Open No. 2016-120545). In the disclosure of Japanese Patent Laid-Open No. 2016-120545, geometric information on the workpiece is obtained by imaging the workpiece using a camera, and then the finger is controlled to grip the workpiece based on this geometric information. Then, at a time of imaging the workpiece, the finger is retracted to the outside of an image pickup area.

### SUMMARY OF THE INVENTION

According to a first aspect of the present invention, an end effector includes a base portion, an imaging apparatus supported by the base portion, and a tool movably supported by the base portion, the tool being configured to support a workpiece and perform work with respect to the workpiece. The base portion includes a driving mechanism. In a case of capturing an image of an imaging object by the imaging apparatus, the driving mechanism is configured to position the tool supporting the workpiece outside of a range in which at least part of the tool or the workpiece supported by the tool overlaps with the imaging object in a field of view of the imaging apparatus.

According to a second aspect of the present invention, a robot system includes an end effector including a base portion, an imaging apparatus that is supported by the base portion and is configured to capture an image, and a tool that is movably supported by the base portion and is configured to perform work with respect to a workpiece, a robot to which the end effector is attached, the robot being configured to move a position and posture of the end effector, and a control unit configured to control the robot and the end effector. In a case of capturing the image of an imaging object by the imaging apparatus, the control unit is configured to position the tool supporting the workpiece outside of a range in which at least part of the tool or the workpiece supported by the tool overlaps with the imaging object in a field of view of the imaging apparatus.

According to a third aspect of the present invention, a robot system includes an end effector including an imaging apparatus and an irradiation unit configured to irradiate light in an optical axis direction, a robot to which the end effector is attached, the robot being configured to move a position and posture of the end effector, and a control unit configured to control the robot and the end effector. When performing alignment control to align the end effector with respect to an imaging object based on an image captured by the imaging apparatus, the control unit is configured to capture the image of an imaging object, that includes a flat surface portion formed in a planar shape and an inclined portion inclined with respect to the flat surface portion, by the imaging apparatus in a manner irradiating by the irradiation unit such that an optical axis of reflected light reflected at the flat surface portion is directed toward the imaging apparatus and an optical axis of reflected light reflected at the inclined portion is directed toward a direction away from the imaging apparatus.

According to a fourth aspect of the present invention, a control method of an end effector including a base portion, an imaging apparatus supported by the base portion, and a tool configured to perform work with respect to a workpiece, the method including a positioning step in which, in a case of capturing an image of an imaging object by the imaging apparatus, the control unit positions the tool supporting the workpiece outside of a range in which at least part of the tool or the workpiece supported by the tool overlaps with the imaging object in a field of view of the imaging apparatus.

According to a fifth aspect of the present invention, a control method of a robot system including an end effector including a base portion, an imaging apparatus supported by the base portion, and a tool configured to perform work with respect to a workpiece, a robot to which the end effector is attached, the robot being configured to move a position and posture of the end effector, and a control unit configured to control the robot and the end effector, the method includes a positioning step in which, in a case of capturing an image of an imaging object by the imaging apparatus, the control unit positions the tool supporting the workpiece outside of a range in which at least part of the tool or the workpiece supported by the tool overlaps with the imaging object in a field of view of the imaging apparatus.

According to a sixth aspect of the present invention, a control method of a robot system including an end effector including an imaging apparatus configure to perform imaging and an irradiation unit configured to irradiate light in an optical axis direction, a robot to which the end effector is attached, the robot being configured to move a position and posture of the end effector, and a control unit configured to control the robot and the end effector, the method including an irradiating step in which the control unit irradiates an imaging object, that includes a flat surface portion formed in a planar shape and an inclined portion inclined with respect to the flat surface portion, by the irradiation unit such that an optical axis of reflected light reflected at the flat surface portion is directed toward the imaging apparatus and an optical axis of reflected light reflected at the inclined portion is directed toward a direction away from the imaging apparatus, an imaging step in which the control unit captures the image of the imaging object, that is irradiated with the light at the irradiating step, by the imaging apparatus, and a calculating step in which the control unit calculates a positional relationship between the end effector and the imaging object from the image captured by the imaging apparatus.

Further features of the present invention will become apparent from the following description of exemplary embodiments with reference to the attached drawings.

### BRIEF DESCRIPTION OF THE DRAWINGS

FIG. 1 is a diagram illustrating a robot system according to a first embodiment.

FIG. 2 is a block diagram illustrating a control system of the robot system according to the first embodiment.

FIG. 3 is a perspective view illustrating a robot hand according to the first embodiment.

FIG. 4 is a bottom view illustrating the robot hand in a state in which a workpiece gripped by a finger portion is located in a field of view of a camera.

FIG. 5 is a bottom view illustrating the robot hand in a state in which the workpiece gripped by the finger portion is located outside of the field of the view of the camera.

FIG. 6 is a side view illustrating a configuration of the finger portion of the robot hand.

FIG. 7 is a block diagram illustrating image-based visual servo control in a robot apparatus.

FIG. 8 is a flowchart illustrating the image-based visual servo control in the robot apparatus.

FIG. 9 is a flowchart illustrating pin assembly control according to the first embodiment.

FIG. 10A is a schematic diagram illustrating a camera image at a time of gripping a pin by the finger portion.

FIG. 10B is a schematic diagram illustrating a camera image when the robot hand has been moved to an overhead position above a hole portion of an assembly workpiece.

FIG. 10C is a schematic diagram illustrating a camera image when the finger portion and the pin have been moved outside of the field of view.

FIG. 10D is a schematic diagram illustrating a camera image when the robot hand has been aligned with respect to the hole portion of the assembly workpiece.

FIG. 10E is a schematic diagram illustrating a camera image when the finger portion and the pin have been moved to the overhead position above the hole portion of the assembly workpiece.

FIG. 11 is a flowchart illustrating pin assembly control according to a second embodiment.

FIG. 12A is a schematic diagram illustrating a camera image when the pin has been gripped by the finger portion.

FIG. 12B is a schematic diagram illustrating a camera image when the robot hand has been moved to the overhead position above the hole portion of the assembly workpiece in a state in which the finger portion and the pin have been moved outside of the field of view.

FIG. 12C is a schematic diagram illustrating a camera image when the robot hand has been aligned with respect to the hole portion of the assembly workpiece.

FIG. 12D is a schematic diagram illustrating a camera image when the finger portion and the pin have been moved to the overhead position above the hole portion of the assembly workpiece.

FIG. 13 is a schematic diagram illustrating configurations of the camera and an illumination unit according to a third embodiment.

FIG. 14A is a diagram illustrating an image when the hole portion of the assembly workpiece has been imaged by a standard camera.

FIG. 14B is a diagram illustrating an image when the hole portion of the assembly workpiece has been imaged by the camera according to the third embodiment.

FIG. 15A is a diagram illustrating an image when a pin placement stand has been imaged by a standard camera with the pin placed in a hole portion.

FIG. 15B is a diagram illustrating an image when the pin placement stand has been imaged by the camera according to the third embodiment with the pin placed in the hole portion.

FIG. 16 is a flowchart illustrating the posture correction control of a robot arm.

FIG. 17A is a schematic diagram illustrating the robot arm before posture correction.

FIG. 17B is a schematic diagram illustrating the robot arm after the posture correction.

### DESCRIPTION OF THE EMBODIMENTS

In Japanese Patent Laid-Open No. 2016-120545 described above, in a case where a workpiece has been transitioned to a state of being gripped by a finger, an installation position for installing the workpiece is obstructed by the workpiece, and cannot be imaged by a camera.

Therefore, since the installation position for installing the workpiece cannot be accurately determined and it is not possible to accurately correct a position of the finger, there is a problem that the accuracy of the installation position during an installation operation of the workpiece decreases.

Therefore, this disclosure provides an end effector, a robot system, a control method of the end effector, a control method of the robot system, a manufacturing method of an article, a program, and a computer readable medium, all of which are capable of imaging an imaging object while supporting the workpiece with a tool.

### First Embodiment

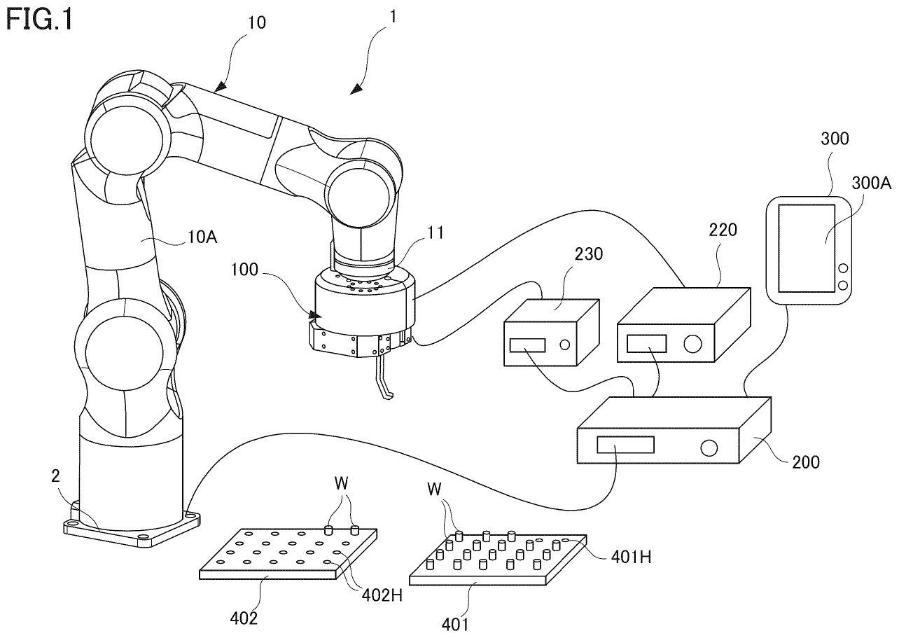

Hereinafter, a first embodiment for implementing this disclosure will be described using FIGS. 1 to 10E.

### Overview of Robot System

First, using FIG. 1, an overview of a robot system according to this first embodiment will be described. FIG. 1 is a diagram illustrating the robot system according to the first embodiment.

As illustrated in FIG. 1, the robot system 1, which is installed in, for example, such as a factory, includes a robot apparatus 10 that grips and moves a pin W from a pin placement stand 401, in which the metallic pin W, serving as a workpiece, is placed, to an assembly workpiece 402. The robot apparatus 10 includes a base 2, a robot arm 10A, serving as a robot main body of a six-axis articulated robot supported on the base 2, and a robot hand 100, serving as an end effector attached to a distal end of the robot arm 10A. That is, the robot arm 10A is a so-called manipulator, and a flange shaped flange portion 11 to which the robot hand 100 is attached is disposed at its distal end.

To be noted, a plurality of hole portions 401H into which the pin W is inserted are formed in the pin placement stand 401, and the pin W, which is supplied as a pre-operation component, is disposed in the hole portion 401H. In addition, a hole portion 402H is formed in the assembly workpiece 402 into which the pin W, serving as the workpiece, is assembled by being inserted and fitted. That is, when the robot apparatus 10 executes assembly control, described in detail below, an operation of assembling the pin W into the assembly workpiece 402 is performed, and, when a plurality of pins W are assembled into the assembly workpiece 402, the completed assembly workpiece 402 is produced as the article.

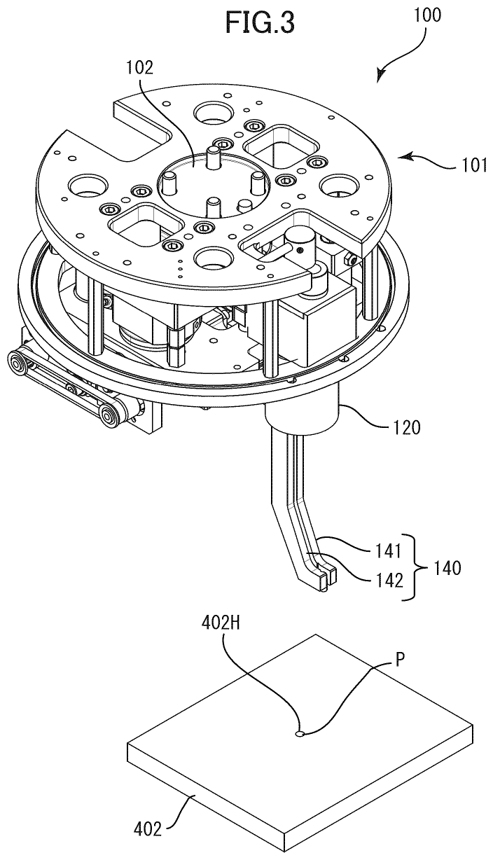

In addition, the robot apparatus 10 includes a robot controller 200 controlling the robot arm 10A, a vison controller 220 controlling a camera 120 (refer to FIG. 3), described in detail below, and a hand controller 230 controlling the robot hand 100. That is, each of these controllers is electrically connected to their respective devices so as to enable to output instructions.

In addition, the robot controller 200 is configured to allow the connection of a teaching pendant 300, serving as a teaching device for a user to perform such as a teaching operation (i.e., teaching) of the robot apparatus 10. In addition, the teaching pendant 300 includes a display portion 300A, serving as a display performing a display of various information. To be noted, while, in this embodiment, the teaching pendant 300, serving as the teaching device, and the display portion 300A, serving as the display, are integrated with each other, each device may be configured as a separate device.

The teaching pendant 300 drives the robot arm 10A by issuing instructions to the robot controller 200, and is configured to manipulate a position and the posture of the robot arm 10A by controlling a position and an angle of each joint of the robot arm 10A. In addition, since the teaching pendant 300 can manipulate the position and the posture of the robot arm 10A, it means that the teaching pendant 300 is configured to manipulate also a position and the posture of the robot hand 100. Then, it is possible to store the position and the posture of the robot arm 10A or the position and the posture of the robot hand 100, which have been manipulated by the teaching pendant 300, in a hard disc drive (HDD) 204, serving as a storage unit, described below. Thereby, the position and the posture of the robot arm 10A or the position and the posture of the robot hand 100 during various operations (assembly operation and positional correction operation) are stored in the robot apparatus 10, that is, the teaching is performed. The robot apparatus 10 is brought to perform various operations (various types of work) based on the position and the posture of the robot arm 10A or the position and the posture of the robot hand 100, which have been stored.

### Configuration of Control System of Robot System

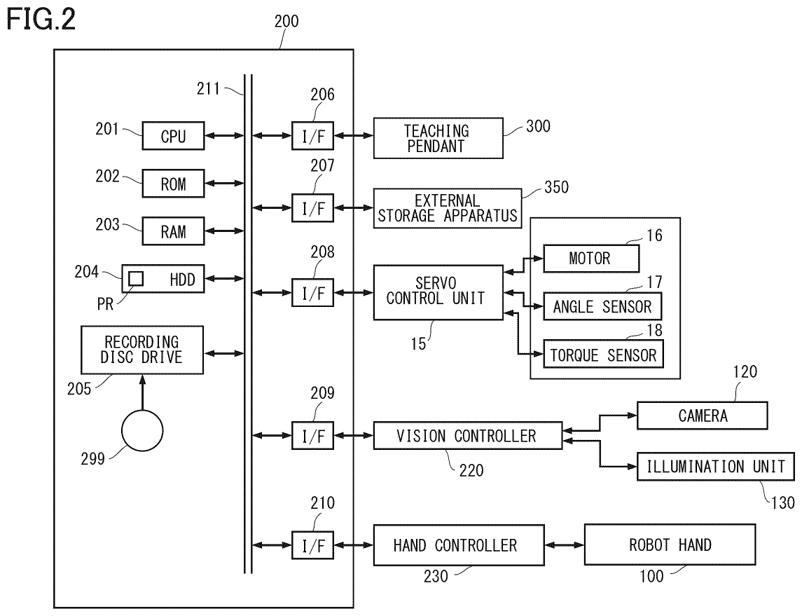

Next, using FIG. 2, a control system of the robot system 1 will be described. FIG. 2 is a block diagram illustrating the control system of the robot system according to the first embodiment.

As illustrated in FIG. 2, the robot controller 200 is configured with a computer. The robot controller 200 includes a central processing unit (CPU) 201, serving as a processor and a control unit. In addition, the robot controller 200 includes a read only memory (ROM) 202, a random access memory (RAM) 203, and the hard disk drive (HDD) 204, each serving as an example of a storage unit.

Further, the robot controller 200 includes a recording disk drive 205 and a plurality of input/output interfaces (I/F) 206 to 210.

The ROM 202, the RAM 203, the HDD 204, the recording disk drive 205, and interfaces 206 to 210 are connected to the CPU 201 via a bus 211. In the ROM 202, basic programs such as a basic input/output system (BIOS) are stored. The RAM 203 is a storage unit that temporarily stores various data such as an arithmetic processing result of the CPU 201.

The HIDD 204 is a storage unit that stores such as the arithmetic processing result of the CPU 201 and various data obtained from the outside. A program PR for instructing the CPU 201 to execute the arithmetic processing is recorded on this HDD 204. Based on the program PR recorded (stored) on the HDD 204, the CPU 201 executes each process of various control (control method) and manufacturing methods of articles, described below. The recording disk drive 205, serving as a computer readable medium, can read such as various data and programs recorded on a recording disk 299. That is, it is possible to read the program PR recorded on the recording disk drive 205 and install it onto the HDD 204.

The teaching pendant 300 is connected to the interface 206. The CPU 201 obtains input data (input information) from the teaching pendant 300 via the interface 206 and the bus 211. In addition, the CPU 201 performs various displays by transmitting image data to the display portion 300A (refer to FIG. 1) disposed in the teaching pendant 300 via the bus 211 and the interface 206. The interface 207 is configured to allow the connection of an external storage device 350 that is a storage unit such as a rewritable non-volatile memory or an external HDD.

A servo control unit 15 is connected to the interface 209. A motor 16, an angle sensor 17, and a torque sensor 18 that are provided at each joint of the robot arm 10A (refer to FIG. 1) are connected to the servo control unit 15. To be noted, in this FIG. 2, a configuration of one of the plurality of joints is illustrated as a representative. The motor 16 is, for example, a brushless direct current (DC) motor or alternating current (AC) motor, and rotatably drives a corresponding joint via a reduction gear, not shown. The angle sensor 17 is, for example, a rotary encoder, and, by being disposed to the motor 16, is configured to detect a rotation angle of the motor 16. The torque sensor 18 is disposed to the corresponding joint, and is configured to detect the torque that acts on the corresponding joint.

That is, the CPU 201 can obtain angle information from the angle sensor 17 and torque information from the torque sensor 18 via the servo control unit 15, the interface 208, and the bus 211. To be noted, the servo control unit 15 may convert the angle of the motor 16, which has been detected using the angle sensor 17, into the angle information of the corresponding joint by dividing the angle of the motor 16 by a reduction ratio of the reduction gear, not shown, and then transmit this converted angle information of the corresponding joint to the CPU 201. Then, the CPU 201 outputs data of command values corresponding to each joint to the servo control unit 15 via the bus 211 and the interface 208 at predetermined time intervals (for example, 1 millisecond (ms)). Thereby, the motor 16 is driven, and its joint is driven. That is, the robot arm 10A is drive controlled to achieve positions and postures corresponding to the command values by the CPU 201 (robot controller 200).

The vision controller 220 is connected to the interface 209. A camera 120, serving as an imaging apparatus, is connected to the vision controller 220, and, under the control of the CPU 201, the vision controller 220 performs imaging by the connected camera 120 at predetermined time intervals (for example, 30 ms). Thereby, the CPU 201 can obtain visual information, namely data of a captured image, from the vison controller 220 at the predetermined time intervals (for example, 30 ms). In addition, an illumination unit 130 is connected to the vision controller 220, and, based on the instructions from the CPU 201, the vision controller 220 controls an ON/OFF state and the intensity of illumination light.

The hand controller 230 is connected to the interface 210. The robot hand 100 described above is connected to the hand controller 230. The hand controller 230 opens and closes the finger portion 140 by driving a first motor 161 and a second motor 151, described in detail below, under the control of the CPU 201.

### Configuration of Robot Hand

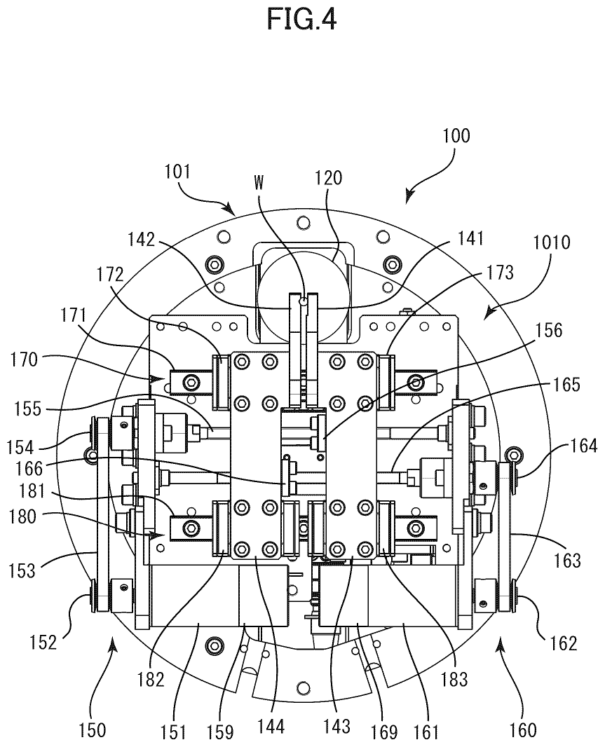

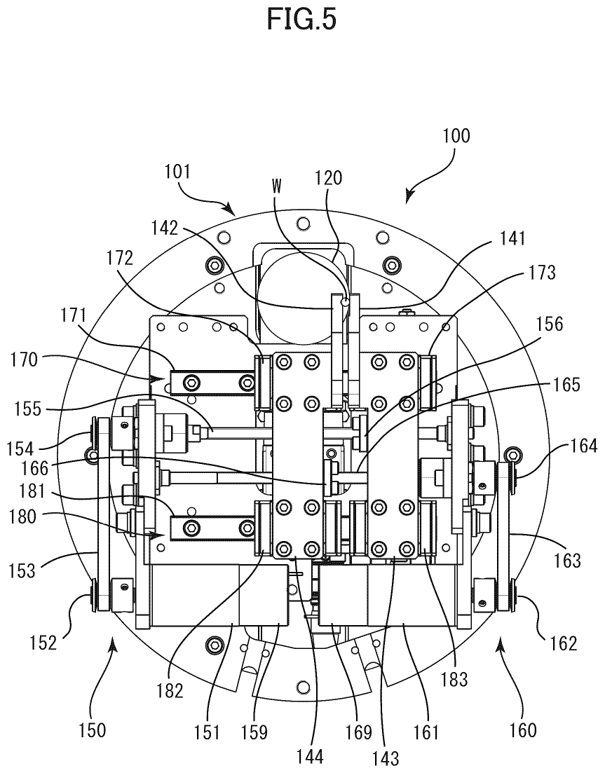

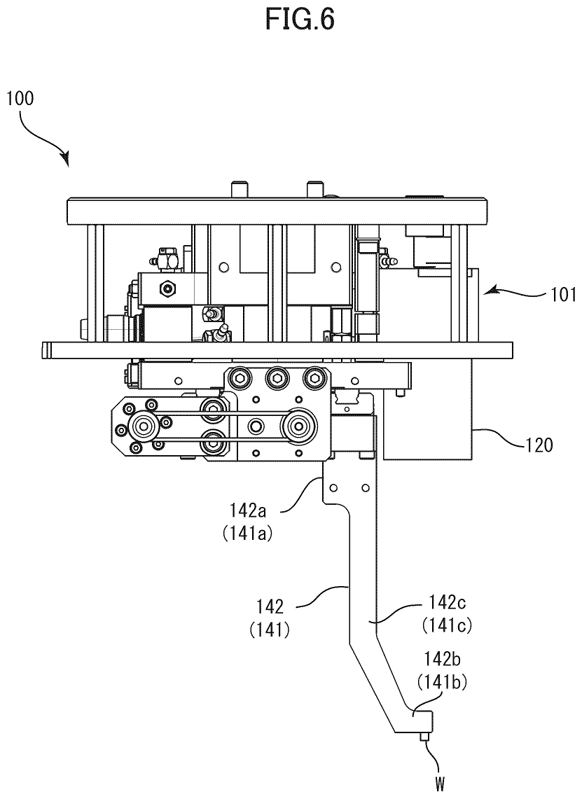

Next, using FIGS. 3, 4, 5, and 6, a detailed configuration of the robot hand 100 will be described. FIG. 3 is a perspective view illustrating the robot hand according to the first embodiment. FIG. 4 is a bottom view illustrating the robot hand in a state in which the workpiece gripped by a finger portion is located in a field of view of the camera. FIG. 5 is a bottom view illustrating the robot hand in a state in which the workpiece gripped by the finger portion is located outside of the field of view of the camera. FIG. 6 is a side view illustrating a configuration of the finger portion of the robot hand.

As illustrated in FIG. 3, the robot hand 100 that is detachably attached to the distal end of the robot arm 10A (refer to FIG. 1) is primarily configured by being equipped with a base portion 101, serving as a main body portion, the camera 120, and the finger portion 140, serving as a tool and a hand. The base portion 101 includes an attachment portion 102 attached to the flange portion 11 (refer to FIG. 1) of the robot arm 10A described above, and the camera 120 capable of imaging is secured to and supported by the base portion 101. By controlling the robot arm 10A, the robot hand 100 is moved to an overhead position at a predetermined distance above the assembly workpiece 402, and the camera 120 is position controlled such that a focal point P (refer to FIG. 3) is aligned with the hole portion 402H of the assembly workpiece 402. Thereby, the camera 120 becomes possible to image the hole portion 402H, serving as the imaging object, a work object, and a contact position. To be noted, similarly, also in a case of imaging the pin W placed in the pin placement stand 401 or the hole portion 401H, the camera 120 is position controlled such that the focal point P (refer to FIG. 3) is aligned with the hole portion 401H of the pin placement stand 401 or the pin W. In this case, the imaging object becomes the hole portion 401H or the pin W, and the work object and the contact position become the pin W placed in the hole portion 401H.

In addition, a first finger portion 141 and a second finger portion 142 constituting the finger portion 140 that is capable of performing work with respect to the pin W, serving as the workpiece, are movably supported by the base portion 101. A first fingertip portions 141b of the first finger portion 141 and a second fingertip portion 142b of the second finger portion 142 can support the pin W by holding it between each other. As described in detail below, the first fingertip portions 141b of the first finger portion 141 and the second fingertip portion 142b of the second finger portion 142 are positioned between the base portion 101 and the focal point P (refer to FIG. 3) of the camera 120 in a state of being present in the field of view of the camera 120. Thereby, the camera 120 becomes possible to image a distant area beyond the first and second finger portions 141 and 142, and the CPU 201 becomes possible to perform various control based on such an image.

Next, a driving mechanism 1010 that movably drives the finger portion 140 will be described. As described above, as illustrated in FIGS. 3 and 4, the finger portion 140 includes the first and second finger portions 141 and 142, and is configured to grip the pin W that is the workpiece. The first finger portion 141 is secured to a first slider 143, and the second finger portion 142 is secured to a second slider 144. Then, the base portion 101 includes a first guide portion 170 and a second guide portion 180, which movably guide the first and second sliders 143 and 144, a first drive unit 150 driving the first slider 143, and a second drive unit 160 driving the second slider 144. The driving mechanism 1010 is constructed by including the first and second sliders 143 and 144, the first and second guide portions 170 and 180, and the first and second drive units 150 and 160, described above.

In particular, the first guide portion 170, serving as a sliding portion, includes a first linear motion guide 171, and movable portions 172 and 173 that are slidingly movably supported by the first linear motion guide 171. In addition, the second guide portion 180, serving as the sliding portion, includes a second linear motion guide 181, and movable portions 182 and 183 that are slidingly movably supported by the second linear motion guide 181. Then, the first slider 143 is secured with respect to the movable portions 173 and 183, and the second slider 144 is secured with respect to the movable portions 172 and 182.

On the other hand, the first drive unit 150 is primarily configured by including a motor 151, a drive pulley 152, a belt 153, a driven pulley 154, a ball screw shaft 155, a ball nut 156, and an angle detection sensor 159. That is, the motor 151 outputs drive rotation, and the drive pulley 152 secured to an output shaft of the motor 151 is rotatably driven. The belt 153 is stretched over the drive and driven pulleys 152 and 154, and the rotation of the driven pulley 152 is transmitted to the driven pulley 154. The driven pulley 154 is secured to one end of the ball screw shaft 155, and, by rotating the ball screw shaft 155, the ball nut 156 secured to the first slider 143 via a ball, not shown, is slidingly moved in an axial direction. Therefore, the first slider 143 is linearly slidingly moved in the axial direction of the ball screw shaft 155 (in a direction along the first and second linear motion guides 171 and 181) while being guided by the first and second guide portions 170 and 180. Therefore, the first finger portion 141 is movably driven in the axial direction of the ball screw shaft 155 in accordance with a rotational direction of the motor 151. For example, when the motor 151 is rotated forward, the first finger portion 141 moves to one side toward the right in FIG. 4, and, when the motor 151 is rotated in reverse, the first finger portion 141 moves to the other side toward the left in FIG. 4. In addition, a rotation angle of the motor 151 is detected by the angle detection sensor 159 that is, for example, configured with such as an encoder, and is output to the robot controller 200 via the hand controller 230 described above. Based on this, the CPU 201 determines a position of the first finger portion 141 through arithmetic processing, and, in addition, by instructing the drive of the motor 151 based on that position, controls the position of the first finger portion 141.

Similarly, also the second drive unit 160 is primarily configured by including a motor 161, a drive pulley 162, a belt 163, a driven pulley 164, a ball screw shaft 165, a ball nut 166, and an angle detection sensor 169. That is, the motor 161 outputs the drive rotation, and the drive pulley 162 secured to an output shaft of the motor 161 is rotatably driven. The belt 163 is stretched over the drive and driven pulleys 162 and 164, and the rotation of the driven pulley 162 is transmitted to the driven pulley 164. The driven pulley 164 is secured to one end of the ball screw shaft 165, and, by rotating the ball screw shaft 165, the ball nut 166 secured to the second slider 144 via a ball, not shown, is slidingly moved in an axial direction. Therefore, the second slider 144 is linearly slidingly moved in the axial direction of the ball screw shaft 165 while being guided by the first and second guide portions 170 and 180. Therefore, the second finger portion 142 is driven to move in the axial direction of the ball screw shaft 165 in accordance with a rotational direction of the motor 161. For example, when the motor 161 is rotated forward, the second finger portion 142 moves to one side toward the left in FIG. 4, and, when the motor 161 is rotated in reverse, the second finger portion 142 moves to the other side toward the right in FIG. 4. In addition, a rotation angle of the motor 161 is detected by the angle detection sensor 169 that is, for example, configured with such as the encoder, and is output to the robot controller 200 via the hand controller 230 described above. Based on this, the CPU 201 determines a position of the second finger portion 142 through the arithmetic processing, and, in addition, by instructing the drive of the motor 161 based on that position, controls the position of the second finger portion 142.

Since the drive mechanism 1010 of the base portion 101 is configured as described above, the first and second finger portions 141 and 142 can each independently move on the same first and second linear motion guides 171 and 181. Thereby, the first and second finger portions 141 and 142 can reduce misalignment in relative positions in directions other than moving directions of the first and second finger portions 141 and 142 when moving in a state of gripping the pin W, and it is possible to facilitate movement control in the state of gripping the pin W.

In addition, by disposing the second linear motion guide 181 on a side opposite to a gripping position of the pin W with the first guide 171 in between, a moment force generated at a time of installing the pin W can be supported by the two linear motion guides. Therefore, it becomes possible to improve the durability of the first and second linear motion guides 171 and 181.

In a case of gripping the pin W by the first and second finger portions 141 and 142, first, the rotation angles of the motors 151 and 161 are respectively detected by the angle detection sensors 159 and 169. Then, based on these values, the CPU 201 controls the motors 151 and 161 such that the first and second finger portions 141 and 142 are spaced to match the pin W and are aligned with the position of the pin W. Thereby, the pin W is gripped by the first and second finger portions 141 and 142.

In addition, the first and second finger portions 141 and 142 can move in the same direction along the first and second linear motion guides 171 and 181 while maintaining spacing between each other, that is, can move while gripping the pin W. That is, the first and second finger portions 141 and 142 can be moved from positions illustrated in FIG. 4 to positions illustrated in FIG. 5. This state illustrated in FIG. 5 is a state in which the first and second finger portions 141 and 142 are at retracted positions positioned outside of the field of view (hereinafter, simply referred to as “out of view”) of the camera 120. This movement to out of view of the camera 120 will be described in a section on pin assembly control described below. To be noted, when moving the first and second finger portions 141 and 142 while gripping the pin W, the first and second finger portions 141 and 142 maintain the spacing between each other. Therefore, the CPU 201 controls such that the positions of the first and second finger portions 141 and 142 are moved in a coordinated manner based on the values detected by the angle detection sensors 159 and 169.

Here, using FIG. 6, shapes of the first and second finger portions 141 and 142 will be described. The second finger portion 142 includes a second base portion 142a secured to the second slider 144 described above, the second fingertip portion 142b that comes into contact with and grips the pin W, and a second connecting portion 142c that connects these second base portion 142a and second fingertip portion 142b. To be noted, similarly, also the first finger portion 141 includes a first base portion 141a secured to the first slider 143 described above, the first fingertip portion 141b that comes into contact with and grips the pin W, and a first connecting portion 141c that connects these first base portion 141a and first fingertip portion 141b. To be noted, since the shapes of the first and second finger portions 141 and 142 are substantially the same, the shape of the second finger portion 142 will be described, and descriptions of the first finger portion 141 will be omitted herein.

The second base portion 142a is positioned offset to the left in FIG. 6 with respect to an imaging direction (i.e., optical axis direction) of the camera 120, and is linearly slidingly moved as described above at a position that does not intersect the imaging direction. Then, the second connecting portion 142c is formed in a bent shape such that the second fingertip portion 142b is directed toward the imaging direction, that is, is formed such that the second fingertip portion 142b can enter the field of view (hereinafter, simply referred to as “the FOV”) of the camera 120. That is, since the second fingertip portion 142b moves linearly parallel to the second base portion 142a due to a sliding movement of the second base portion 142a, the second fingertip portion 142b moves from out of view of the camera 120 to out of view by passing through the FOV.

Since the shapes of the first and second finger portions 141 and 142 are formed as described above, it is possible to image the first and second fingertip portions 141b and 142b together with the pin W that is gripped. Then, in the image captured by the camera 120, the first and second fingertip portions 141b and 142b are visible, but other than those, i.e., the first and second connecting portions 141c and 142c and the first and second base portions 141a and 142a are not captured. Thereby, when the camera 120 captures the image, it is possible to minimize a region where the first and second finger portion 141 and 142 overlap with work positions (such as the hole portion 402H of the assembly workpiece 402, the hole portion 401H of the pin placement stand 401, and the pin W placed in the pin placement stand 401). In addition, by this bent shape as described above, it is possible to compactly achieve a structure that, even when the first and second finger portions 141 and 142 are moved, does not interfere with the camera 120 and allows the imaging of the first and second fingertip portions 141b and 142b. Thereby, it is possible to achieve the miniaturization of the robot hand 100.

### Visual Servo Control

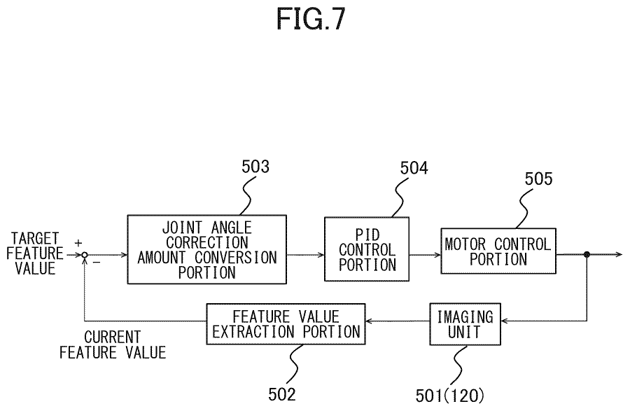

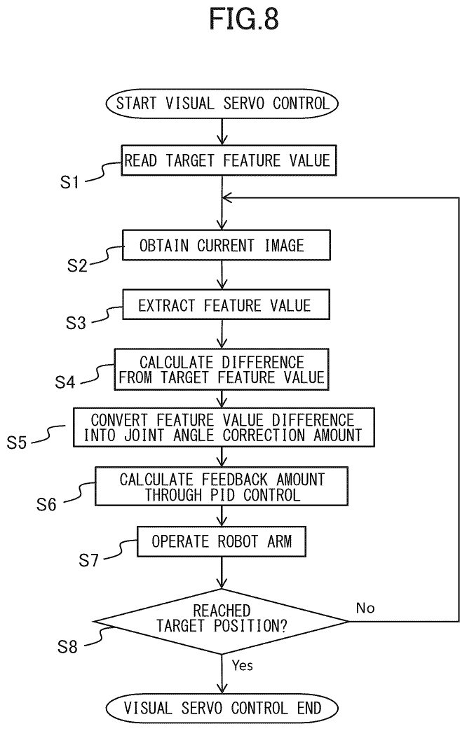

Next, using FIGS. 7 and 8, image-based visual servo control that controls a position and the posture of the robot arm 10A will be described. FIG. 7 is a block diagram illustrating the image-based visual servo control in the robot apparatus. FIG. 8 is a flowchart illustrating the image-based visual servo control in the robot apparatus. To be noted, a configuration of each unit illustrated in the block diagram of FIG. 7 indicates a function that is implemented by the CPU 201 when executing the program PR. Therefore, these functions are actually accomplished by operations of such as the robot controller 200, the vision controller 220, and the camera 120.

The visual servo control is a method used to control the position and the posture of the robot arm 10A, where changes in a position of a target are measured as visual information and used as information for feedback control. In addition, the image-based visual servo control is a type of the visual servo control that extracts an image feature contained in the target object on a current image and feedbacks a difference from an image feature on the target image. In the visual servo control of this embodiment, the alignment or the correction of the position of the robot hand 100 is performed with respect to the hole portion 402H of the assembly workpiece 402, the hole portion 401H of the pin placement stand 401, and the pin W placed in the pin placement stand 401, which are the imaging objects. Therefore, the visual servo control can be also said to be alignment control or correction control.

As illustrated in FIGS. 7 and 8, when the robot controller 200 starts the image-based visual servo control according to this embodiment, first, the vison controller 220 reads the target image stored in the HDD 204, and retrieves a target feature value (STEP S1). That is, the feature value is extracted from the target image, and is set as the target feature value. Next, when the imaging is instructed by an imaging unit 501, the camera 120 images the hole portion 402H of the assembly workpiece 402 or the hole portion 401H of the pin placement stand 401, and obtains this as the current image (STEP S2). Next, a feature value extraction portion 502 extracts a current feature value from the obtained current image (STEP S3).

Next, a joint angle correction amount conversion portion 503 first calculates a difference in the feature value between the current feature value obtained at STEP S3 and the target feature value obtained at STEP S1 (STEP S4). Then the joint angle correction amount conversion portion 503 converts the difference in the feature value into a correction amount of an angle of each joint (hereinafter, referred to as a “joint angle correction amount”) of the robot arm 10A (STEP S5).

Next, a proportional-integral-derivative (PID) control portion 504 applies suitable PID control to each joint angle correction amount and calculates a control amount of the feedback control (hereinafter, referred to as a “feedback amount”) (STEP S6). Next, by transmitting the calculated feedback amount to the servo control unit 15, and by driving the motors 16 at each axis, the robot arm 10A is operated (STEP S7).

Then, the CPU 201 determines whether or not the robot arm 10A which was operated has reached a target position, or, in more particular, has reached within an allowable tolerance range of the target position (STEP S8). Here, for example, in a case where the feedback amount calculated at STEP S6 described above has exceeded a predetermined range, it is determined that the position and the posture of the robot arm 10A have not yet converged to the vicinity of the target position (STEP S8: No). In this case, by returning to STEP S2 described above, processes subsequent to the acquisition of the current image are re-executed. By repeating the loop process from STEP 2 to STEP S8 as described above at a high speed, the robot arm 10A can be converged to the target position and posture. That is, the robot arm 10A can be reached to a target positional relationship with respect to the hole portion 402H of the assembly workpiece 402 or the hole portion 401H of the pin placement stand 401. Then, when the robot arm 10A has reached the target position (STEP S8: Yes), thereby, the image-based visual servo control ends.

### Pin Assembly Control of First Embodiment

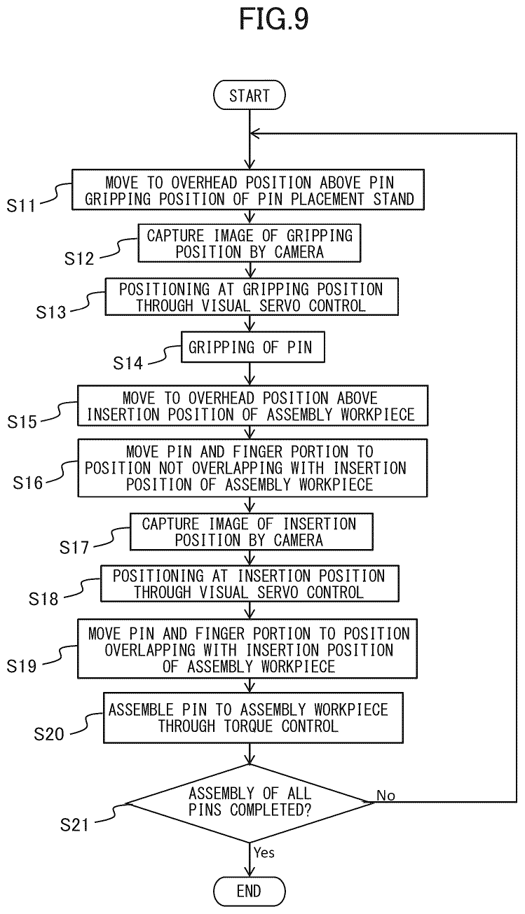

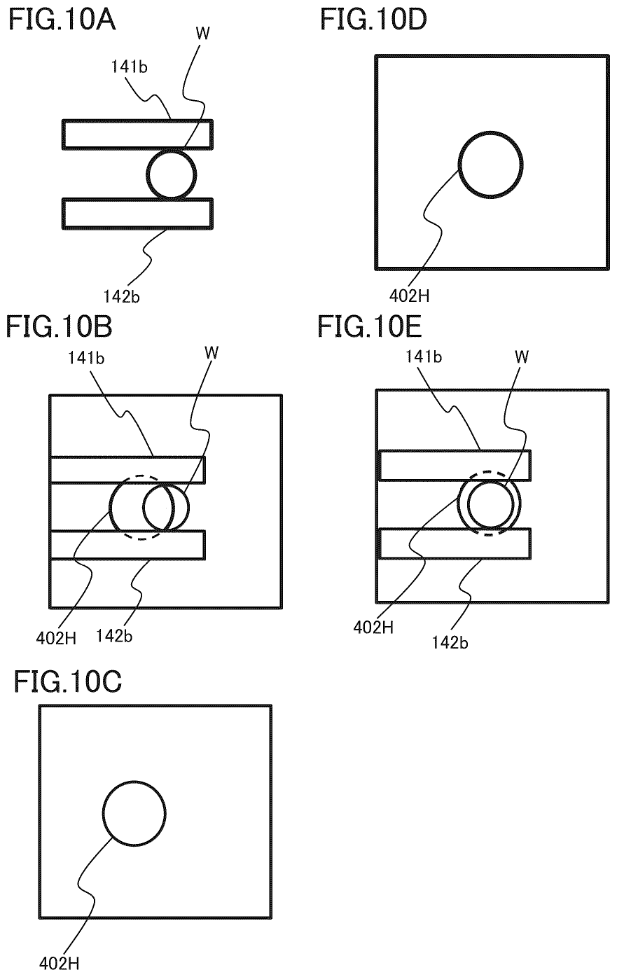

Next, using FIGS. 9 to 10E, the pin assembly control according to the first embodiment will be described. FIG. 9 is a flowchart illustrating the pin assembly control according to the first embodiment. FIG. 10A is a schematic diagram illustrating a camera image when the pin is gripped by the finger portion. FIG. 10B is a schematic diagram illustrating a camera image when the robot hand is moved to an overhead position above the hole portion of the assembly workpiece. FIG. 10C is a schematic diagram illustrating a camera image when the finger portion and the pin are moved out of view. FIG. 10D is a schematic diagram illustrating a camera image when the robot hand is aligned with respect the hole portion of the assembly workpiece. FIG. 10E is a schematic diagram illustrating a camera image when the finger portion and the pin are moved to the overhead position above the hole portion of the assembly workpiece.

In the pin assembly control according to the first embodiment, using the robot apparatus 10, a first operation of gripping (acquiring) the pin W installed in the hole portion 401H of the pin placement stand 401, and a second operation of moving the pin W and inserting the pin W into the hole 402H of the assembly workpiece 402 for assembly are performed. By repeating these first and second operations, a plurality of pins W are inserted and assembled into each of the hole portions 402H of the assembly workpiece 402, and the assembly workpiece 402 that has been completed is manufactured as the article.

In particular, as illustrated in FIG. 9, first, the CPU 201 roughly drives the robot arm 10A to move the robot hand 100 such that the robot hand 100 is positioned at the overhead position above the pin W disposed in the pin placement stand 401 (STEP S11). That is, the CPU 201 roughly drives the robot arm 10A to position the finger portion 140 at the overhead position above the location for gripping the pin W.

Next, the CPU 201 images the pin W of the pin placement stand 401 (imaging step), that is, obtains an image in which a gripping position where the finger portion 140 of the robot hand 100 grips the pin W is captured (STEP S12). Then, the CPU 201 performs the visual servo control described above, and aligns the robot arm 10A such that the finger portion 140 is aligned with the gripping position of the pin W (aligning step). That is, by using the obtained image of pin W as the current image, a difference in the feature value of the pin W from the target image is calculated, and the robot arm 10A is controlled to converge the difference in the feature value. In other words, an image captured by the camera 120 and the target image are compared, and a misalignment amount from an optimal gripping position of the pin W is calculated. Then, the calculated misalignment amount is converted into posture data of the robot arm 10A to which the robot hand 100 has been attached, and positioning with respect to the pin W is performed by using those posture data. As described above, the robot arm 10A is positioned, and the finger portion 140 is positioned at the gripping position of the pin W.

Thereafter, so as to obtain the pin W with the robot hand 100, by driving the first and second finger portions 141 and 142 of the robot hand 100 by the motors 151 and 161 as described above, the pin W is gripped by the finger portion 140 (STEP S14). As illustrated in FIG. 10A, in this state, within the FOV of the camera 120, there are the first fingertip portion 141b of the first finger portion 141, the second fingertip portion 142b of the second finger portion 142, and the pin W that is gripped, and these are all in a state of being imaged.

Next, to insert and attach the gripped pin W into the hole portion 402H of the assembly workpiece 402, the CPU 201 moves the robot hand 100 by the robot arm 10A with the pin W gripped by the finger portion 140 (STEP S15). That is, the CPU 201 moves the robot hand 100 to the overhead position above the hole portion 402H (insertion position) of the assembly workpiece 402. In this state, as illustrated in FIG. 10B, within the FOV of the camera 120, there are the first fingertip portion 141b, the second fingertip portion 142b, and the pin W that is gripped, and any of these is a state in which it is imaged in a manner of overlapping with the hole portion 402H of the assembly workpiece 402. In other words, a range in which, in the field of view of the camera 120, at least part of the first fingertip portion 141b, the second fingertip portion 142b, and the pin W that is gripped overlaps with the hole portion 402H of the assembly workpiece 402 is referred to as an overlapping range. In this case, part of any one or part of more than one of the first fingertip portion 141b, the second fingertip portion 142b, and the pin W that is gripped are positioned within the overlapping range. Therefore, the camera 120 is in a state of incapable of imaging the hole portion 402H of the assembly workpiece 402 by being obstructed by any of the first fingertip portion 141b, the second fingertip portion 142b, and the pin W that is gripped. In addition, since, in this state, as illustrated in FIG. 10B, the visual servo control of the robot arm 10A based on the imaging of the hole portion 402H has not been completed, it is highly probable that the pin W gripped by the finger portion 140 and the hole portion 402H are in a misaligned state.

Therefore, before the camera 120 performs the imaging of the hole portion 402H (insertion position) of the assembly workpiece 402, the first fingertip portion 141b of the first finger portion 141, the second fingertip portion 142b of the second finger portion 142, and the pin W are moved to become out of view of the camera 120 (STEP S16). That is, the first finger portion 141, the second finger portion 142, and the pin W are retracted to become out of view of the camera 120 (retracting step) (refer to FIG. 5). In particular, by driving the motors 151 and 161, the first and second finger portions 141 and 142 are slidingly moved while gripping the pin W, and the first fingertip portion 141b, the second fingertip portion 142b, and the pin W are moved to positions that do not overlap with the hole portion 402H of the assembly workpiece 402. At this time, by not changing the position and the posture of the robot arm 10A, that is, maintaining the position and the posture of the robot hand 100, only the first and second finger portions 141 and 142 are moved. When this state is achieved, as illustrated in FIG. 10C, the first finger portion 141, the second finger portion 142, and the pin W are retracted from within the FOV of the camera 120, and the direct imaging of the hole portion 402H of the assembly workpiece 402 is allowed.

To be noted, while, in this embodiment, the first finger portion 141, the second finger portion 142, and the pin W are moved out of view of the camera 120, it is acceptable as long as these do not obstruct the imaging of the hole portion 402H of the assembly workpiece 402 by the camera 120. Therefore, if the first finger portion 141, the second finger portion 142, and the pin W are moved to be positioned outside of the overlapping range described above, it is acceptable even if they remain within the FOV of the camera 120.

As describe above, when the first finger portion 141, the second finger portion 142, and the pin W are moved to be positioned out of view of the camera 120, the image of the hole portion 402H, serving as the insertion position where the pin W is inserted, of the assembly workpiece 402 is imaged by the camera 120 (imaging step) (STEP S17). Then, the visual servo control is performed again, and, here, the robot arm 10A is aligned such that the camera 120 is correctly aligned with respect to the hole portion 402H of the assembly workpiece 402, which serves as the insertion position (aligning step) (STEP S18). That is, by using the obtained image of the hole portion 402H as the current image, the difference in the feature value between the hole portion 402H and the target image is calculated, and the robot arm 10A is controlled to converge the difference in the feature value. In other words, the image captured by the camera 120 and the target image are compared, and a misalignment amount from an optimal position for inserting the pin W into the hole portion 402H is calculated. Then, the calculated misalignment amount is converted into posture data of the robot arm 10A to which the robot hand 100 has been attached, and positioning with respect to the hole portion 402H is performed by using such posture data. As described above, the robot arm is positioned, and the robot hand 100 is positioned with respect to the hole portion 402H. In addition, in this state, as illustrated in FIG. 10D, the pin W gripped by the fingertip portion 141b of the first finger portion 141 and the second fingertip portion 142b of the second finger portion 142 is positioned out of view of the camera 120. Therefore, the hole portion 402H of the assembly workpiece 402 is in a state of being imaged, for example, substantially at the center of the field of view of the camera 120.

Next, when the camera 120 has completed the imaging of the hole portion 402H (insertion position) of the assembly workpiece 402, before performing the work of inserting the pin W into the hole portion 402H of the assembly workpiece 402, the finger portion 140 is restored to its original position in the robot hand 100 (restoring step). That is, the first and second finger portions 141 and 142 are moved such that at least part of the pin W, gripped by the first and second finger portions 141 and 142, is located at a position that overlaps with the hole portion 402H of the assembly workpiece 402 within the FOV of the camera 120 (STEP S19). In particular, by driving the motors 151 and 161, the first and second finger portions 141 and 142 are slidingly moved while gripping the pin W, and moved to the position where the pin W overlaps with the hole portion 402H of the assembly workpiece 402 (refer to FIG. 4). Also at this time, by not changing the position and the posture of the robot arm 10A, that is, maintaining the position and the posture of the robot hand 100, only the first and second finger portions 141 and 142 are moved. When transitioning to this state, as illustrated in FIG. 10E, within the FOV of the camera 120, the first fingertip portion 141b of the first finger portion 141, the second fingertip portion 142b of the second finger portion 142, and the pin W are returned to their original positions before retraction. In addition, by positioning the position and the posture of the robot hand 100 at the correct position with respect to the hole portion 402H through the visual servo control, the pin W is accurately moved to a position that overlaps with the hole portion 402H of the assembly workpiece 402 substantially directly above.

Finally, the robot arm 10A is operated under torque control, and the pin W gripped by the finger portion 140 of the robot hand 100 is inserted and assembled into the hole portion 402H of the assembly workpiece 402 (STEP S20). That is, by driving the robot arm 10A, the robot hand 100 is moved, and the pin W gripped by the finger portion 140 of the robot hand 100 is brought into contact with the hole portion 402H of the assembly workpiece 402. Then, the torque sensors 18 on each joint of the robot arm 10A detect a reaction force generated by the contact of the pin W with the hole portion 402H, and the motors 16 are torque controlled to produce pushing forces that are in a direction of reducing the reaction force and move the pin W downward. As described above, it is possible to regulate copying assembly, in which the pin W follows the hole portion 402H, and the pushing force through the torque control, and the pin W is inserted without encountering significant resistance by following the hole portion 402H. In addition, the gripping of the pin W by the finger portion 140 is released by separating the first and second finger portions 141 and 142 from each other, and, thereby, the pin W is assembled into the hole portion 402H of the assembly workpiece 402. To be noted, since, as described above, the hole portion 402H serves also as a position where the pin W is brought into contact, also a position where the work of inserting to assemble the pin W is performed, and also as a position where the pin W is installed, it can be also said to be the contact position, the work position, or the installation position.

Then, the CPU 201 determines whether or not the assembly of the all pins W into the assembly workpiece 402 has been completed as the work (STEP S21). For example, the number of the pins W to be assembled into the assembly workpiece 402 is stored in such as the HDD 204 in advance, and the CPU 201 determines based on the number of assembly operations that have been completed. In a case where the assembly of all the pins W has not been completed (STEP S21: No), the CPU 201 returns to STEP S11, and repeats the processes up to STEP S20 described above, that is, the work on the next pin W.

To be noted, while it becomes a trade-off with processing performance and computation time, multiple recognition processes are executed in parallel during initial visual servo control (STEPS S13 and S18) even if there are differences in hole shapes and diameters. Then, central positions and the diameter length of the hole portions 401H of the pin placement stand 401 and the hole portions 402H of the assembly workpiece 402 are extracted as the feature value. Thereby, since positioning by the visual servo control after the second time is possible, it is acceptable to read the target image used in previous visual servo control and set it as the target feature value.

When the assembly of all the pins W with respect to the assembly workpiece 402 has been completed through the execution of the pin assembly control as described above (STEP S21: Yes), thereby, the CPU 201 ends the pin assembly control of this embodiment.

### Summary of First Embodiment

As described above, according to the first embodiment, when obtaining the current image by imaging the assembly workpiece 402 with the camera 120, the finger portion 140 and the pin W are moved to be retracted from the overlapping range overlapping with the hole portion 402H of the assembly workpiece 402 in the field of view of the camera 120. Thereby, in a state in which the finger portion 140 remains to grip and support the pin W, serving as the workpiece, it is possible to capture the contact position or the work position without being obstructed by the pin W, that is, it is possible to obtain the current image without being obstructed by the pin W. Therefore, it is possible to accurately align the robot hand 100 with respect to the hole portion 402H, and it is possible to improve the accuracy of the assembly position (contact position, installation position) in the assembly operation (contact operation, installation operation) of the pin W.

In addition, before imaging the hole portion 402H by the camera 120, the finger portion 140 and the pin W that is gripped are moved from a state in which the finger portion 140 and the pin W that is gripped are located inside of the overlapping range in the field of view of the camera 120 to the outside of the overlapping range. Therefore, it is possible to image the hole portion 402H without the finger portion 140 and the pin W obstructing the hole portion 402H. In addition, when moving the finger portion 140 and the pin W that is gripped, the robot arm 10A is not driven, that is, a position and the posture of the base portion 101 of the robot hand 100 are not changed, and only the finger portion 140 is moved. Thereby, for example, it is possible to accurately perform the correction of the position and the posture of the robot hand 100 by the visual servo control.

In addition, from the state in which the finger portion 140 and the pin W that is gripped are located outside of the overlapping range described above, before performing the assembly operation (work) by the finger portion 140, the finger portion 140 and the pin W that is gripped are moved such that the pin W overlaps with the hole portion 402H in the field of view of the camera 120. Therefore, it is possible to align the pin W with the assembly position in the hole portion 402H. In addition, similarly, when moving the finger portion 140 and the pin W that is gripped, the robot arm 10A is not driven, that is, the base portion 101 of the robot hand 100 does not change the position and the posture, and only the finger portion 140 is moved. Thereby, it is possible to accurately align the pin W with respect to the hole portion 402H.

In addition, in the robot hand 100, the first and second guide portions 170 and 180 are driven by the first and second drive units 150 and 160 such that the first base portion 141a of the first finger portion 141 and the second base portion 142a of the second finger portion 142 move slidingly. Thereby, without changing the position and the posture of the robot hand 100, it is possible to move to retract only the finger portion 140, and, in addition, it is also possible to easily restore and realign the retracted finger portion 140 with the hole portion 402H. In addition, since the first and second finger portions 141 and 142 can be driven independently, it is possible to grip the pin W and release the grip.

### Second Embodiment

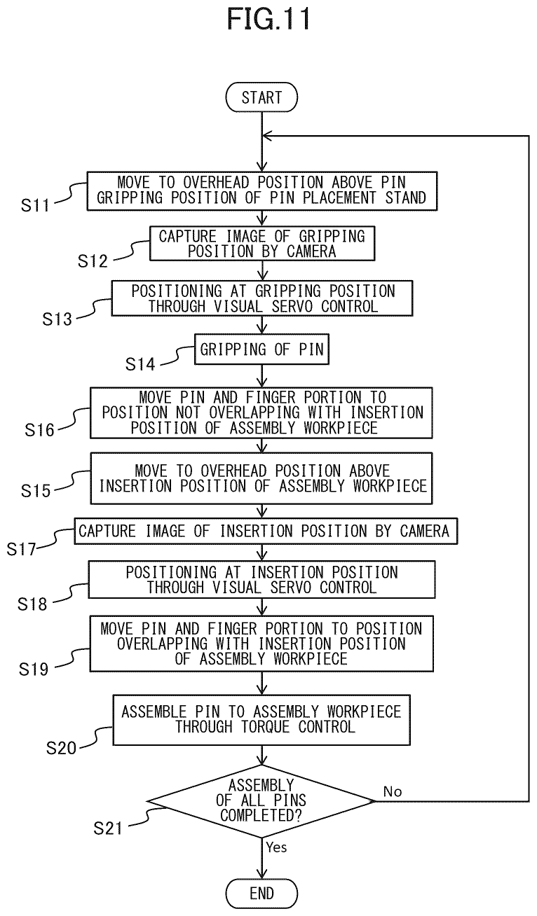

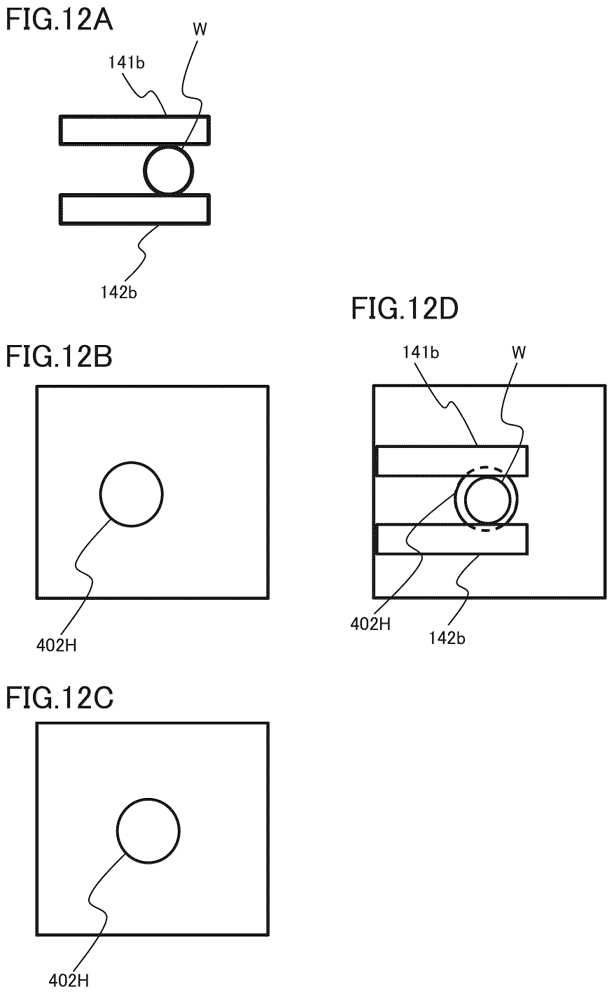

Next, using FIGS. 11 to 12D, a second embodiment in which the first embodiment described above is partly changed will be described. FIG. 11 is a flowchart illustrating pin assembly control according to the second embodiment. FIG. 12A is a schematic diagram illustrating a camera image when the pin is gripped by the finger portion. FIG. 12B is a schematic diagram illustrating a camera image when the robot hand is moved to the overhead position above the hole portion of the assembly workpiece with the finger portion and the pin moved out of view. FIG. 12C is a schematic diagram illustrating a camera image when the robot hand is aligned with respect to the hole portion of the assembly workpiece. FIG. 12D is a schematic diagram illustrating a camera image when the finger portion and the pin are moved to the overhead position above the hole portion of the assembly workpiece.

In the second embodiment, in comparison with the first embodiment described above, the sequence of STEPS S15 and S16 in the pin assembly control is interchanged (refer to FIGS. 9 and 11). That is, after gripping the pin W of the pin placement stand 401 by the finger portion 140 (STEP S14), while (or after) moving the finger portion 140 and the pin W that is gripped (STEP S16), the robot hand 100 is moved to the overhead position above the hole portion 402H of the assembly workpiece 402 (STEP S15).

### Pin Assembly Control of Second Embodiment

In particular, as illustrated in FIG. 11, first, the CPU 201 roughly moves the robot hand 100 by driving the robot arm 10A such that the robot hand 100 is positioned at the overhead position above the pin W installed in the pin placement stand 401 (STEP S11). Next, the CPU 201 images the pin W of the pin placement stand 401, that is, obtains an image in which a gripping position, at which the finger portion 140 of the robot hand 100 grips the pin W, is imaged (imaging step) (STEP S12). Then, the CPU 201 executes the visual servo control described above, and aligns the robot arm 10A such that the finger portion 140 is located at the gripping position of the pin W (aligning step) (STEP S13). Thereafter, by driving the first and second finger portions 141 and 142 by the motors 151 and 161, the CPU 201 performs the gripping of the pin W by the finger portion 140 (STEP S14). In this state, there are the first fingertip portion 141b of the first finger portion 141, the second fingertip portion 142b of the second finger portion 142, and the pin W that is gripped within the FOV of the camera 120, and these are in a state of being imaged.

Here, before the camera 120 performs the imaging of the hole portion 402H of the assembly workpiece 402, the first fingertip portion 141b of the first finger portion 141, the second fingertip portion 142b of the second finger portion 142, and the pin W are moved to be located out of view of the camera 120 (retracting step) (STEP S16). In a movement (retraction) at this time, by registering and storing a predetermined position at which the finger portion 140 and the pin W do not overlap with the hole portion 402H when imaging the hole portion 402H of the assembly workpiece 402 with the camera 120 at a subsequent STEP S17, the finger portion 140 and the pin W are moved to that predetermined position. It is conceivable that this predetermined position is stored in, for example, a storage area such as the HDD 204. When transitioning to this state, as illustrated in FIG. 12B, the first finger portion 141, the second finger portion 142, and the pin W are retracted from within the FOV of the camera 120, and it becomes possible to directly image the hole portion 402H of the assembly workpiece 402.

Next, the CPU 201 moves the robot hand 100 by the robot arm 10A in a state in which the pin W is gripped by the finger portion 140 (STEP S15). That is, the CPU 201 moves the robot hand 100 to the overhead position above the hole portion 402H (insertion position) of the assembly workpiece 402. To be noted, in this embodiment, the CPU 201 simultaneously performs this movement of the finger portion 140, which is gripping the pin W, by the robot hand 100 (STEP S15) and the movement of the robot hand 100 by the robot arm 10A (STEP S16). However, it is acceptable to perform the movement of the robot hand 100 by the robot arm 10A after performing the movement of the finger portion 140, which is gripping the pin W, by the robot hand 100.

Next, the CPU 201 images the hole portion 402H, serving as the insertion position for inserting the pin W, of the assembly work piece 402 by the camera 120 (imaging step) (STEP S17). Then, the CPU 201 again executes the visual servo control, and, here, aligns the robot arm 10A to be correctly positioned with respect to the hole portion 402H, serving as the insertion position, of the assembly work piece 402 (aligning step) (STEP S18). In this state, as illustrated in FIG. 12C, the first fingertip portion 141b of the first finger portion 141, the second fingertip portion 142b of the second finger portion 142, and the pin W that is gripped are located out of view of the camera 120. Therefore, this is a state in which the hole portion 402H of the assembly workpiece 402 is imaged, for example, substantially at the center of the field of view of the camera 120.

Next, when the camera 120 has completed the imaging of the hole portion 402H (insertion position) of the assembly workpiece 402, before performing the work of inserting the pin W into the hole portion 402H of the assembly workpiece 402, the finger portion 140 is restored to its original position in the robot hand 100 (restoring step). That is, the first and second finger portions 141 and 142 are moved such that the pin W, gripped by the first and second finger portions 141 and 142, is located at a position that overlaps with the hole portion 402H of the assembly workpiece 402 within the FOV of the camera 120 (STEP S19). When transitioning to this state, as illustrated in FIG. 12D, within the FOV of the camera 120, the first fingertip portion 141b of the first finger portion 141, the second fingertip portion 142b of the second finger portion 142, and the pin W return to their original positions before retraction. In addition, by positioning the position and the posture of the robot hand 100 at the correct position with respect to the hole portion 402H through the visual servo control, the pin W is accurately moved to the position that overlaps with the hole portion 402H of the assembly workpiece 402 substantially directly above.

Finally, the robot arm 10A is operated under the torque control, and the pin W gripped by the finger portion 140 of the robot hand 100 is inserted and assembled into the hole portion 402H of the assembly workpiece 402 (STEP S20). Thereby, the pin W is inserted by following the hole portion 402H without encountering significant resistance. In addition, the gripping of the pin W by the finger portion 140 is released by separating the first and second finger portions 141 and 142 from each other, and, thereby, the pin W is assembled into the hole portion 402H of the assembly workpiece 402.

Then, the CPU 201 determines whether or not the assembly of all the pins W into the assembly workpiece 402 has been completed as a task (STEP S21), and, in a case where the assembly of all the pins W has not been completed (STEP S21: No), the CPU 201 returns to STEP S11, and repeats the processes up to STEP S20 described above, that is, the work on the next pin W. In addition, when the assembly of all the pins W with respect to the assembly workpiece 402 has been completed (STEP S21: Yes), thereby, the CPU 201 ends the pin assembly control of this embodiment.

### Summary of Second Embodiment

As described above, also in the second embodiment, when obtaining the current image by imaging the assembly workpiece 402 with the camera 120, in the field of view of the camera 120, the finger portion 140 and the pin W are moved and retracted from the overlapping range overlapping with the hole portion 402H of the assembly workpiece 402. Thereby, in a state in which the finger portion 140 remains to grip and support the pin W, serving as the workpiece, it is possible to image the contact position and the work position without being obstructed by the pin W, that is, it is possible to obtain the current image without being obstructed by the pin W.

Then, in this second embodiment, while moving (retracting) the finger portion 140 and the pin W that is gripped (STEP S16), it is possible to simultaneously move the robot hand 100 to the overhead position above the hole portion 402H of the assembly workpiece 402 (STEP S15). Thereby, in comparison with the first embodiment where the finger portion 140 and the pin W are retracted after being temporarily moved to the overhead position above the hole portion 402H of the assembly workpiece 402, it is possible to shorten operating time (work time)

To be noted, since, in the second embodiment, configurations, functions, and effects other than those described above are the same as the first embodiment, their descriptions will be omitted herein.

### Third Embodiment

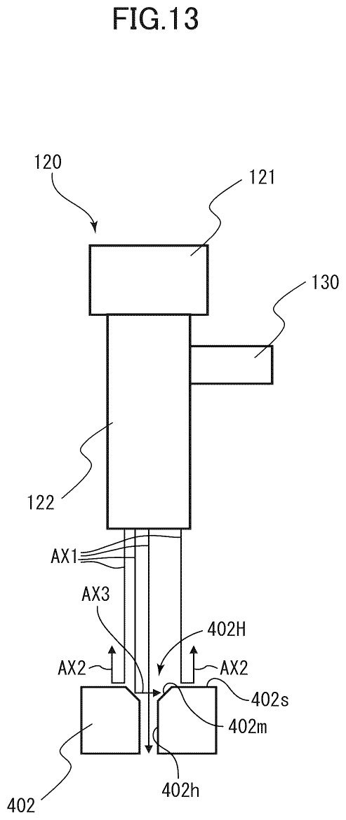

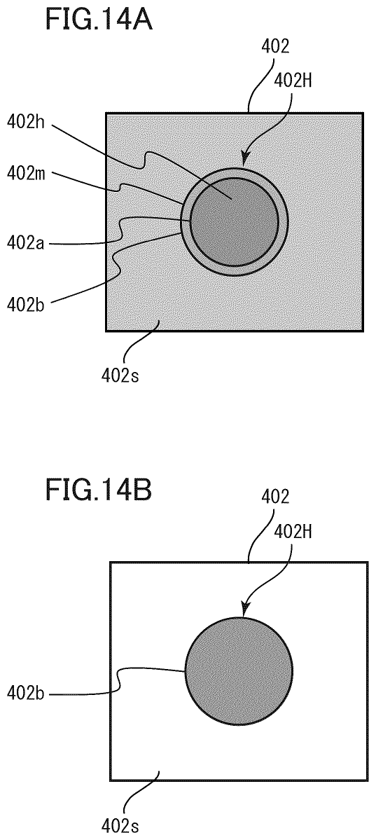

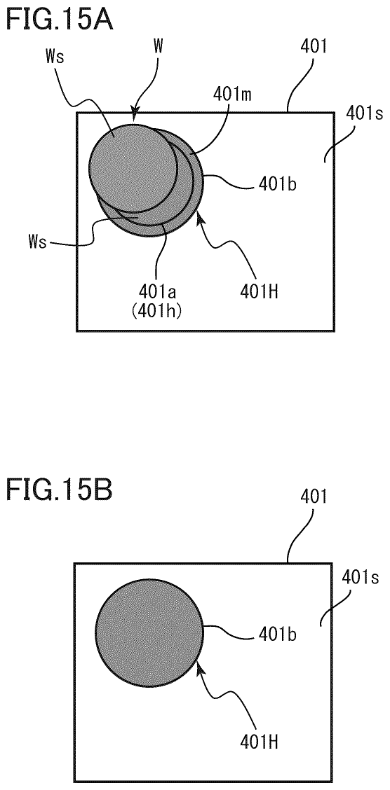

Next, using FIGS. 13 to 15B, a third embodiment in which the first and second embodiments described above are partly changed will be described. FIG. 13 is a schematic diagram illustrating configurations of a camera and an illumination unit according to the third embodiment. FIG. 14A is a diagram illustrating an image which is obtained when the hole portion of the assembly workpiece is imaged by a standard camera. FIG. 14B is a diagram illustrating an image which is obtained when the hole portion of the assembly workpiece is imaged by the camera according to the third embodiment. FIG. 15A is a diagram illustrating an image which is obtained when the pin placement stand in whose hole portion the pin is placed is imaged by the standard camera. FIG. 15B is a diagram illustrating an image which is obtained when the pin placement stand in whose hole portion the pin is placed is imaged by the camera according to the third embodiment.

### Configurations of Camera and Illumination Unit

While, for the camera 120 of the first embodiment described above, the camera equipped with a conventional lens is used, in this third embodiment, the camera 120 is equipped with a telecentric lens 122 that is a telecentric optical system. In addition, the camera 120 is equipped with a coaxial incident illumination unit 130 which is mounted with respect to the telecentric lens 122 and serves as an irradiation unit irradiating illumination light in a direction of an optical axis AX1 (optical axis direction).

In particular, as illustrated in FIG. 13, the camera 120 includes a sensor unit 121 which is an image sensor that scans and obtains an image. In addition, the camera 120 includes the telecentric lens 122 that can capture the image from the direction of the optical axis AX1 into the sensor portion 121 by being connected to that sensor unit 121. Further, the camera 120 also includes the coaxial incident illumination unit 130 serving as a light source that irradiates the illumination light coaxially with the optical axis AX1 via such as a half-mirror, not shown, disposed in the telecentric lens 122.

This telecentric lens 122 refers to a lens where principal rays are parallel to the optical axis AX1. Since a field angle is almost zero degrees and a distortion aberration is reduced, the telecentric lens 122 allows the precise capture of a dimension and a position of an object that is imaged by the sensor unit 121. In addition, the coaxial incident illumination unit 130, which irradiates the irradiation light in a coaxial direction with the optical axis AX1 of the camera 120, irradiates the irradiation light perpendicularly to, for example, a surface 402s of the assembly workpiece 402. Thereby, the sensor portion 121 is enabled to image the surface 402 as being brighter (whiter) than the hole portion 402H. Therefore, for example, in a case where unevenness exists on a surface of the object, it is possible to easily detect the unevenness of the object.

### Case of Imaging Assembly Workpiece

Here, a case of imaging the assembly workpiece 402 by the camera 120 will be described. As illustrated in FIG. 13, the assembly workpiece 402 includes the surface 402s, serving as a flat surface portion formed in a planar shape as described above, and the hole portion 402H is formed in a hole-like shape with respect to the surface 402. The hole portion 402H includes a hole 402h and a chamfered portion 402m, serving as an inclined portion chamfered at an outer edge of its opening. The chamfered portion 402m is formed, for example, as an inclined surface inclined at 45 degrees with respect to the surface 402s. To be noted, the angle of the chamfered portion 402m is preferably inclined at equal to more than 30 degrees with respect to the surface 402s, but any angle is acceptable.

In the case of imaging the assembly workpiece 402, by irradiating the hole portion 402H of the assembly workpiece 402 with the illumination light by the coaxial incident illumination unit 130 (irradiation step), in that state, the hole portion 402H of the assembly workpiece 402 is imaged by the camera 120 (imaging step).

Here, as illustrated in FIG. 14A, in a case where the hole portion 402H of the assembly workpiece 402 is imaged by the standard camera, the hole 402h becomes darker than the surface 402s. However, a difference between light and dark is small, and an inner edge 402a of the chamfered portion 402m and an outer edge 402b of the chamfered portion 402m form a configuration resembling concentric circles. Therefore, it is difficult to distinguish their feature values. In addition, since a difference between the light and dark of the inner and outer edges 402a and 402b is also small, it is difficult to distinguish their feature values. Therefore, incorrect recognition for the position of the hole portion 402H in the image is likely to occur, and even if the visual servo control is performed as described above in this state, a control amount (correction amount) does not stabilize, and the positioning between the robot hand 100 and the hole portion 402H does not achieve high precision.

On the other hand, as illustrated in FIG. 13, in a case of imaging the hole portion 402H of the assembly workpiece 402 by the camera 120 according to the third embodiment, first, the posture of the robot hand 100 is controlled such that the optical axis AX1 of the camera 120 becomes perpendicular to the surface 402s of the assembly workpiece 402. Then, the illumination light is irradiated from the coaxial incident illumination unit 130 toward the optical axis AX1 (irradiating step). Then, the illumination light reflected at the surface 402s is reflected in a direction of an optical axis AX2 in parallel with the optical axis AX1, and is directed to the sensor unit 121 via the telecentric lens 122. In addition, the illumination light irradiated to the hole 402h is not reflected (or absorbed by being diffusely reflected at a bottom surface). Then, the illumination light reflected at the chamfered portion 402m is reflected in a direction of an optical axis AX3 which is different from the optical axis AX1 directed toward the camera 120. That is, the illumination light reflected at the chamfered portion 402m is reflected in a direction away from the camera 120.

Therefore, as illustrated in FIG. 14B, in the case of imaging the hole portion 402H of the assembly workpiece 402 by the camera 120 according to the third embodiment, a region of the surface 402s (surface perpendicular to the optical axis AX1 of the camera 120) outside of the hole portion 402H is imaged brightly (whitely) (imaging step). On the other hand, an inner region of the hole portion 402H, including the chamfered portion 402m, is imaged darkly (blackly). That is, with the outer edge 402b of the chamfered portion 402m as a boundary, the difference between the light and dark is enhanced compared to the case of imaging by the standard camera, and it is possible to highly accurately detect the outer edge 402b of the chamfered portion 402m as the feature value. Therefore, the position of the hole portion 402H in the image is accurately recognized, the control amount (correction amount) when the visual servo control is performed is stabilized, and the positioning between the robot hand 100 and the hole portion 402H achieves high precision.

### Case of Imaging Pin Placement Stand

Here, a case of imaging the pin placement stand 401 by the camera 120 will be described. To be noted, the hole portion 401H of the pin placement stand 401 has the same configuration as the hole portion 402H of the assembly workpiece 402, and a chamfered portion 401m, serving as an inclined portion, is formed at an outer edge of an opening of a hole 401h which is formed in a hole-like shape with respect to a surface 401s, serving as a flat portion formed in a planar shape. The pin W is inserted and placed in the hole 401h which is inside of an inner edge 401a of the chamfered portion 401m.

Also in the case of imaging the pin placement stand 401, the hole portion 401H of the pin placement stand 401 is irradiated with the illumination light by the coaxial incident illumination unit 130 (irradiating step), and, in this state, the hole portion 401H of the pin placement stand 401 is imaged by the camera 120 (imaging step).

Here, depending on a positional relationship between a mounting position of the camera 120 in the robot hand 100 and a position of the finger portion 140 of the robot hand 100, there is a possibility that the gripping position of the pin W is not necessarily at the center of the field angle of the camera 120. Therefore, as illustrated in FIG. 15A, in a case of imaging the hole portion 401H, which is a part of the pin placement stand 401 and a pin hole, by the standard camera, a side portion Ww of the pin W that is protruding is visible with a standard lens. That is, in this image, a head portion Ws of the pin W overlaps with an outer edge 401b of the chamfered portion 401m.

On the other hand. as illustrated in FIG. 15B, in a case of imaging the hole portion 401H of the pin placement stand 401 by the camera 120 according to the third embodiment, in the image captured by the sensor unit 121 via the telecentric lens 122, the side portion Ww of the pin W is not visible. That is, since the telecentric lens is a lens in which the principal rays become parallel with respect to the optical axis, even in a case where a position of the hole portion 401H is not at the center of the field angle of the camera 120, the side portion Ww of the pin W is not visible, and all the outer edge 402b of the chamfered portion 401m is visible. To be noted, while, for example, the pin W is made of metal, since the head Ws of the pin W does not have a polished surface, the illumination light from the coaxial incident illumination unit 130 diffusely reflects, and the head Ws of the pin W is imaged darkly (blackly) even in a case of being imaged.

Even in the case of imaging the hole portion 401H of the pin placement stand 401 by the camera 120 according to the third embodiment as described above, a region outside of the hole portion 401H is imaged brightly (whitely). In addition, on the contrary, a region inside of the hole portion 401H including the chamfered portion 401m is imaged darkly (blackly). That is, with the outer edge 401b of the chamfered portion 401m as a boundary, the difference between the light and dark is enhanced compared to the case of imaging by the standard camera, it is possible to highly accurately detect the outer edge 401b of the chamfered portion 402m as the feature value. Therefore, the position of the hole portion 401H in the image is accurately recognized, the control amount (correction amount) when performing the visual servo control is stabilized, and positioning between the robot hand 100 and the hole portion 401H achieves the high precision.

### Standardization of Target Image

Incidentally, for example, in a case of the standard camera, in a case where there is the pin W as illustrated in FIG. 15A, since a shape that is obtained as the feature value does not become circular, it is necessary to obtain images for each case of the pin W being present and absent in the hole portion 401H. However, in the camera 120 according to the third embodiment, the telecentric lens 122 is used. Therefore, as illustrated in FIG. 15B, regardless of the presence or absence of the pin W in the hole portion 401H, the hole portion 401H (outer edge 402b) is imaged as substantially circular, that is, image recognition is not affected. Thereby, as the target image used when performing the visual servo control described above (refer to FIG. 8, STEP S13 of FIG. 9, and STEP S13 of FIG. 11) to grip the pin W, it becomes possible to use the same target image for any of a plurality of hole portions 401H.

Further, also the target image used when performing the visual servo control (refer to FIG. 8, STEP S13 of FIG. 9, and STEP S13 of FIG. 11) to assemble the pin W into the hole portion 402H of the assembly workpiece 402 is a substantially circular image. Therefore, it becomes possible to standardize and use the same target image in both the visual servo control used to grip the pin W and the visual servo control used to assemble the pin W into the hole portion 402H of the assembly workpiece 402. Especially, even if a position of a target hole changes or a position and a hole diameter are moved by a few millimeters, since the feature value of the image is the same, it is possible to perform the work to grip and assemble the pin W with respect to a plurality of holes using the same target image (the same feature value). To be noted, the same target image does not need to be completely identical, especially in terms of such as size, as long as the shape is the same, it is possible to use such a target image by enlarging or reducing it. That is, the same target image is a target image whose shape of a feature portion is the same, and it can be also said to be the same target image except for the size.

In addition, while, in the above descriptions, the same image is used as the target image, in the visual servo control, the feature value is extracted from the target image, and is set as a target feature value (refer to FIG. 7 and STEP S1 of FIG. 8). Then, this target feature value is used by storing it as data in such as the HDD 204 of the robot controller 200. It is not necessary to perform this process of extracting the target feature value from the target image each time when performing the visual servo control with respect to the plurality of hole portions 401H. That is, the target feature value that has been extracted from the target image at first visual servo control (refer to STEPS S13 of FIGS. 9 and 11) and stored as the data in such as the HDD 204 can be repeatedly read and used in subsequent visual servo control. Further, also for the target feature vale that is used when performing the visual servo control to assemble the pin W into the hole portion 402H of the assembly workpiece 402 (refer to STEP S18 of FIG. 9 and STEP S18 of FIG. 11), the target feature value that has been set at the first visual servo control can be read and used.

### Summary of Third Embodiment

As described above, in the third embodiment, when recognizing the images of the hole portion 402H of the assembly workpiece 402 and the hole portion 401H of the pin placement stand 401, the surfaces 402s and 401s are imaged brightly, and the hole portions 402H and 401H are imaged darkly. That is, the coaxial incident illumination unit 130 irradiates such that the optical axis of the reflected light reflected at the surface 402s or 401s is directed toward the camera 120. Simultaneously with this, the coaxial incident illumination unit 130 irradiates the hole portion 402H or 401H such that the optical axis of the reflected light reflected at the chamfered portion 402m or 401m is directed toward a direction that is different from that of the camera 120. In other words, while being irradiated by the coaxial incident illumination unit 130 with the optical axis AX1 of the telecentric lens 122 being perpendicular to the surface 402s or 401s, the surface 402s or 401s is imaged by the camera 120. Thereby, it becomes possible to highly accurately detect the outer edge 402b of the chamfered portion 402m or the outer edge 401b of the chamfered portion 401m, that is, it is possible to accurately detect the position of the hole portion 402H or 401H in the image that is imaged (obtained). Therefore, the control amount (correction amount) when performing the visual servo control is stabilized, and it is possible to accurately perform the positioning between the robot hand 100 and the hole portion 402H or 401H.

In addition, misalignment between the robot hand 100 and the hole portion 402H of the assembly workpiece 402 or the hole portion 401H of the pin placement stand 401 is calculated from the current image and the target image captured by the camera 120, the position of the robot hand 100 is corrected to eliminate the misalignment. That is, the position of the robot hand 100 is corrected by the visual servo control. Then, since there are the plurality of hole portions 401H in the pin placement stand 401, in the visual servo control performed with respect to each of the hole portions 401H of the pin placement stand 401, the same target image is used. Further, also in the visual servo control performed with respect to each of the plurality of hole portions 402H of the assembly workpiece 402, it is possible to use the target image that has been used for the plurality of hole portions 401H of the pin placement stand 401. Since it is possible to standardize the target image, the teaching operation for teaching the position and the posture of the robot hand 100 is sufficiently performed only by using the standardized target image. That is, for example, the need to individually perform the teaching operation to teach the position and the posture of the robot hand 100 by setting the target image for each hole portion 402H or each hole portion 401H is eliminated, and the teaching operation is simplified. Further, for example, even if hole diameters are different in each of the hole portions 402H of the assembly workpiece 402 or in each of the hole portions 401H of the pin placement stand 401, it is possible to use the same target image. Then, since the image and the feature value of the hole do not change even if the positions of the holes are different, it is possible to use the same target image, and it is possible to greatly reduce the time for the teaching operation.

To be noted, since, in the third embodiment, configurations, functions, and effects other than those described above are the same as the first and second embodiments, their descriptions will be omitted herein.

### Fourth Embodiment

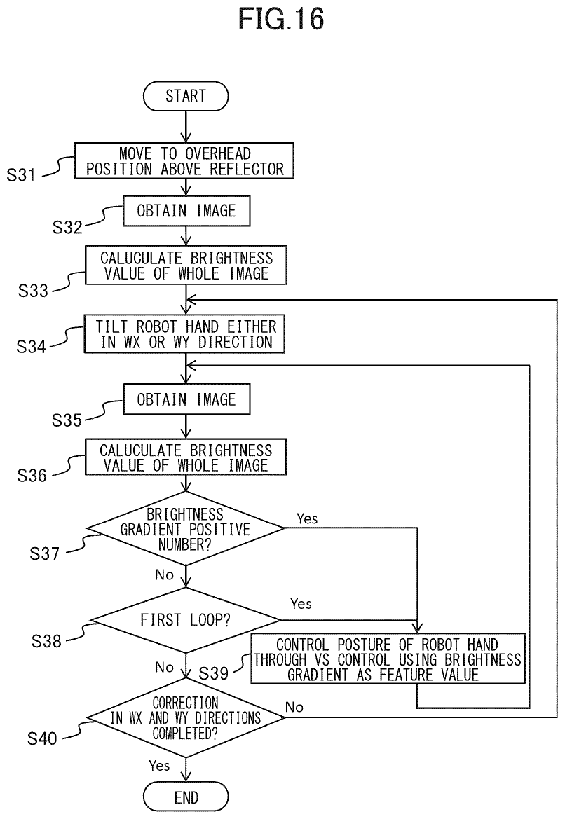

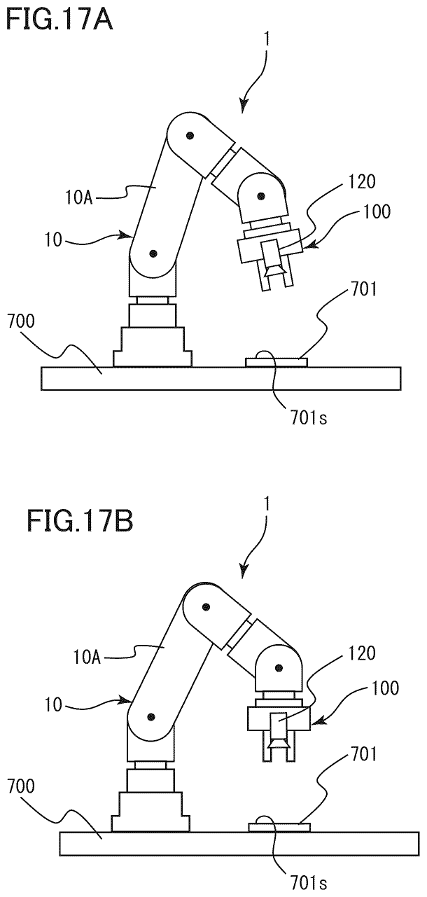

Next, using FIGS. 16 to 17B, a fourth embodiment in which the third embodiment described above is partly changed will be described. FIG. 16 is a flowchart illustrating the posture correction control of the robot arm. FIG. 17A is a schematic diagram illustrating the robot arm before posture correction. FIG. 17B is a schematic diagram illustrating the robot arm after the posture correction.

In the pin assembly control described above, for example, in the case of imaging the pin placement stand 401 by the camera 120, in the case of imaging the assembly work piece 402 by the camera 120, and the like, it is preferable that the robot hand 100 precisely aligns highly accurately with respect to the pin placement stand 401 or the assembly workpiece 402. Similarly, in the pin assembly control described above, for example, in the case of gripping the pin W by the finger portion 140, in the case of inserting the pin W into the hole portion 402H by the finger portion 140, and the like, it is preferable that the robot hand 100 precisely aligns highly accurately with respect to the pin placement stand 401 or the assembly workpiece 402. Further, not limited to the pin assembly control described above, for example, even in the teaching operation to teach an operation of the robot arm 10A, there are cases where it is preferable for the posture of the robot hand 100 to be precisely aligns highly accurately with respect to the pin placement stand 401 or the assembly workpiece 402. Therefore, in this fourth embodiment, a process of performing the posture correction control to correct the posture of the robot hand 100 to precisely align it with the object will be described. The term “precisely align” refers to a state in which a direction of a central axis (a central axis of the robot hand 100, the optical axis AX1 of the camera 120) becomes perpendicular to a surface of the object (the surface 401s of the pin placement stand 401 or the surface 402s of the assembly workpiece 402).

### Posture Correction Control of Robot Arm

First, when performing the posture correction control of the robot arm 10A according to the fourth embodiment, as illustrated in FIGS. 17A and 17B, a calibration plate 701 that possesses a surface 701s reflecting the illumination light to a stand 700 is installed. To be noted, in a case of a workpiece having a surface that can reflect the illumination light, such as a workpiece with a metallic shine, without using the calibration plate 701, it is acceptable to install such a workpiece. Especially, since the surface 401s of the pin placement stand 401 and the surface 402s of the assembly workpiece 402 possess the shine and reflect the illumination light, their use is acceptable.

Further, the camera 120 equipped with the robot hand 100 according to this fourth embodiment includes the telecentric lens 122 and the coaxial incident illumination unit 130 described in the third embodiment. However, it is acceptable to use the standard camera as the camera 120. In addition, in FIGS. 17A and 17B, only the robot arm 10A is illustrated as the robot system 1. However, as illustrated in FIGS. 1 and 2, the robot system 1 includes such as the robot controller 200, the vision controller 220, and is configured to allow the connection of the teaching pendant 300.

As illustrated in FIG. 16, first, the CPU 201 of the robot controller 200 operates the robot arm 10A, and, as illustrated in FIG. 17A, moves and positions the robot hand 100 at the overhead position above the calibration plate 701 (reflector) (STEP S31). In this case, there is a possibility that the posture of the robot hand 100 (flange portion 11, which is an end effector of the robot arm 10A) may tilt due to such as positioning errors and may not be precisely aligned with the calibration plate 701 (reflector). Therefore, the CPU 201 proceeds to the following control.

Next, the CPU 201 obtains an image of the calibration plate 701 from the overhead position by the camera 120 (STEP S32). Then, the CPU 201 calculates a brightness value from the whole of the obtained image (STEP S33). By calculating the brightness value, it is possible to determine the degree to which the light irradiated from the optical axis AX1 of the camera 120 has been reflected and returned. This enables the measurement of a degree of the precise alignment between the robot hand 100 (flange portion 11 of the robot arm 10A) and the calibration plate 701.

Next, the CPU 201 tilts the flange portion 11 (i.e., robot hand 100) of the robot hand 10A by, for example, a predetermined amount in either a wx direction or a wy direction. To be noted, here, when the lateral direction of the image is defined as an X-axis and the vertical direction of the image is defined as a Y-axis, a rotational movement around the X-axis is referred to as the wx direction, and a rotational movement around the Y-axis is referred to as the wy direction. A rotation direction during tilting can be either clockwise or counterclockwise, that is, either rotation direction is acceptable.

Next, with the flange portion 11 of the robot arm 10A tilted from a state of previous image acquisition, the CPU 201 obtains the image of the calibration plate 701 again by the camera 120 (STEP S35). Then, the CPU 201 calculates the brightness value from the whole of the image obtained with the flange portion 11 of the robot arm 10A tilted (STEP S36). Then, from a difference between the brightness values obtained before and after tilting the flange portion 11 of the robot arm 10A, the CPU 201 calculates a brightness gradient, and determines whether or not the brightness gradient is a positive number (STEP S37). In a case where the brightness gradient is the positive number, an increase in the bright value of the whole of the image, that is, the image has become brighter is indicated. Therefore, if the difference between the brightness values obtained before and after tilting the flange portion 11 of the robot arm 10A is the positive number, it is shown that tilting in that direction will bring it to a more precise alignment. Therefore, if the brightness gradient is the positive number (STEP S37: Yes), using the brightness gradient as the feature value, a posture of the flange 11 (end effector) of the robot arm 10A is actuated through the visual servo control (STEP S39). Thereafter, the CPU 201 repeats the processes from STEP S35 to STEP S39, and performs the process until the brightness gradient becomes no longer the positive number and becomes a negative number, that is, until the brightness value of the captured image has almost reached its maximum.

Thereafter, when the brightness gradient ceases to be the positive number (STEP S37: No), the CPU 201 determines whether or not previous processes are in a first loop (STEP S38). For example, at STEP S34, there is a possibility that the flange 11 of the robot arm 10A is tilted to a direction in which the brightness value decreases. Therefore, even if the brightness gradient is the negative number, if the previous processes are in the first loop (STEP S38: Yes), correction to tilt to the opposite direction is performed through the visual servo control (STEP S39). Then, if the previous processes are not in the first loop (STEP S38: No), the CPU 201 determines whether or not correction in both the wx and wy directions has been completed (STEP S40). In a case where the correction in both the wx and wy directions has not been completed (STEP S40: No), the CPU 201 returns to STEP S35 again, and performs correction in a posture direction that has not been completed. Then, in a case where the correction in both the wx and wy directions has been completed (STEP S40: Yes), thereby, the CPU 201 ends the posture correction control of the robot arm. As the posture correction has been performed until the brightness gradient became the negative number and the brightness value obtained from the image reached nearly its maximum, as illustrated in FIG. 17B, the flange portion 11 (i.e., robot hand 100) of the robot arm 10A becomes precisely aligned with the calibration plate 701.

To be noted, while, in this fourth embodiment, the posture correction control of the robot arm is performed by the correction control of the visual servo control, it is not limited to this. For example, it is acceptable to perform the correction of the posture as follows: installing a user interface (UI) in the teaching pendant 300, displaying the brightness value on the display portion 300A, and manually manipulating the robot arm 10A while observing that information. Especially, in a case where the teaching of the robot arm 10A is performed by using the teaching pendant 300, this posture correction method is effective. Further, even if the brightness value is displayed on the display portion 300A, it is acceptable that, by feeding back the brightness value to the robot controller 200, the robot controller 200 is allowed to perform some or all of the posture control processes described above. In addition, while, as an example, the display portion 300A of the teaching pendant 300 is used as a display portion that displays the brightness value, it is not limited to this, and, by connecting another display unit such as a monitor, it is acceptable to display the brightness value there.

In addition, especially, in a case where the posture correction is performed when performing the teaching of the robot arm 10A, the image and posture information obtained when performing the correction are stored in such as the HDD 204 after performing the posture correction. Then, by summoning those image and posture information before executing the pin assembly control, it is acceptable to perform movement control to precisely align the robot hand 100 with the pin placement stand 401 or the assembly workpiece 402 by using those image and posture information.

In addition, in a case where a standard illumination unit and lens are used for the camera, while the posture correction accuracy described above decreases, correction in a depth direction becomes possible. Therefore, it is acceptable to configure the setup such that the correction is performed by combining two cameras of the standard camera and the camera 120 equipped with the telecentric lens 122.

### Summary of Fourth Embodiment

According to the posture correction control of the robot arm in this fourth embodiment described above, it is possible to precisely align the robot hand 100 with the target workpiece (pin placement stand 401 or assembly workpiece 402). Therefore, it becomes possible to actually perform the precise fitting, such as a few micrometers, between the pin W and the finger portion 140, between the pin W and the hole portion 402H, or the like. Further, it is possible to facilitate the teaching operation for performing such precise fitting. In addition, by performing this posture correction control of the robot arm before or during the execution of the pin assembly control described above, it is possible to ensure the precise alignment even if the robot hand 100 is tilted due to changes in robot operations and environmental conditions, and it is possible to reliably perform the work such as the precise fitting described above. In addition, by executing this posture correction control of the robot arm, the brightness value of the image captured in the pin assembly control becomes its maximum, and it is possible to improve the accuracy of the image recognition. Then, by using a plurality of cameras, it is possible to increase not only the recognition accuracy of the position within the image but also recognition accuracy in the depth direction.

### Possibility of Other Embodiments

To be noted, while, in the first to fourth embodiments described above, the hole portion 401H (work position, contact position), serving as the imaging object, of the pin placement stand 401 or the hole portion 402H of the assembly workpiece 402 is imaged in a state in which the finger portion 140 and the pin W that is gripped by the finger portion 140 are retracted. At this time, while the position of the pin W is retracted by moving the finger portion 140 or the position of the pin W is restored by moving the finger portion 140, it is not limited to this, and it is acceptable to retract and restore the pin W together with the robot hand 100 by driving the robot arm 10A. That is, if a positional relationship between the pin W and the work position (contact position) is known, it is possible to perform retraction and restoration by moving the robot arm 10A by a required distance.

In addition, while, in the first to fourth embodiments, the camera 120 is attached to and supported by the base portion 101 of the robot hand 100, it is not limited to this. For example, by slidingly moving the camera 120 with respect to the base portion 101 of the robot hand 100 without moving the finger portion 140, the pin w can be retracted and restored with respect to the camera 120 as a relative positional relationship between the camera 120 and the finger portion 140. Further, the camera 120 may be attached to the robot arm 10A, or, further, may be installed at a fixed point (such as the ceiling) within an installation location where the robot system 1 is installed. Especially, in a case where the camera 120 is installed at the fixed point, the pin W may be retracted and restored with respect to the camera 120 by the movement of the robot arm 10A. In summary, it is acceptable as long as, when imaging the imaging object (work position, contact position) with the camera 120, to prevent obstruction by the workpiece, the tool and the workpiece are moved to a position where the tool and the workpiece do not overlap with the workpiece within the FOV of the camera 120. Then, in a case of restoring the workpiece to the position of the imaging object for executing the work with respect to the workpiece, it is acceptable if the imaging object is not imaged by being obstructed by the workpiece but also that the camera 120 moves synchronously with the workpiece and the imaging object is not imaged within the FOV of the camera 120.

In addition, while, in the first to fourth embodiments, the finger portion 140 of the robot hand 100 functions as a tool and acts as the end effector to grip the pin W, serving as the workpiece, it is not limited to this. For example, such as a driver that serves as a tool which engages with a screw, serving as the workpiece, to enable screwing can be considered. Further, it is not limited to a device that grips and supports the workpiece, and, for example, it can also include a device that supports the workpiece through means such as suction or magnetic adhesion.

In addition, while, in the first to fourth embodiments, the robot hand 100 slidingly moves the first and second finger portions 141 and 142, it is not limited only to this configuration. For example, it may have equal to or more than three finger portions, or the finger portion may move on an arc instead of a straight line. In addition, while the first and second guide portions 170 and 180 are included to slidingly move the first and second finger portions 141 and 142, it is not limited to this, and it is acceptable to include one or equal to or more than three guide portions. Needless to say, since the presence of a plurality of guide portions stabilizes the movements of the first and second finger portions 141 and 142 and ensures a secure grip on the workpiece, it is preferable to have equal to or more than two guide portions. In addition, while the first and second finger portions 141 and 142 are driven by the motors 151 and 161, it is not limited to this, and, for example, it is acceptable to drive the first and second finger portions 141 and 142 by such as a solenoid and hydraulic pressure.

In addition, in the third embodiment, by using the telecentric lens 122 and the coaxial incident illumination unit 130, the camera 120 irradiates the irradiation light perpendicularly to the surface of the imaging object, and images on that optical axis. However, it is not limited to this, and, for example, a configuration in which the camera and the illumination unit are not on the same optical axis is also acceptable. In such a case, it is conceivable to set an angle such that the optical axis of the irradiation light is reflected at a flat surface of the imaging target and is directed toward the camera.

In addition, this disclosure is not limited to the embodiments described above, and embodiments can undergo numerous modifications within the technical concept of this disclosure. For example, at least two of the plurality of embodiments and the plurality of variant examples described above may be combined. In addition, the effects described in these embodiments merely list the most favorable effects resulting from the embodiments of this disclosure, and the benefits of the embodiments of this disclosure are not limited to those described in these embodiments.

In addition, while, in the first to fourth embodiments described above, the robot main body is a vertical articulated robot, it is not limited to this. For example, the robot main body may be a horizontal articulated robot, a parallel-link robot, or an orthogonal robot. In addition, the embodiments described above can be applied to machines capable of automatically performing extension, flexion, vertical movement, lateral movement, or rotational movement, as well as composite motions based on information provided by memory devices installed in control units.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-145971, filed Sep. 8, 2023, which is hereby incorporated by reference herein in its entirety.

What is claimed is:

1. An end effector comprising:
a base portion;
an imaging apparatus supported by the base portion; and
a tool movably supported by the base portion, the tool being configured to support a workpiece and perform work with respect to the workpiece,
wherein the base portion includes a driving mechanism, and
wherein, in a case of capturing an image of an imaging object by the imaging apparatus, the driving mechanism is configured to position the tool supporting the workpiece outside of a range in which at least part of the tool or the workpiece supported by the tool overlaps with the imaging object in a field of view of the imaging apparatus.

2. The end effector according to claim 1,
wherein, from a state in which at least part of the tool or the supported workpiece is located inside of the range, before imaging the imaging object by the imaging apparatus, the driving mechanism is configured to move the tool supporting the workpiece outside of the range.

3. The end effector according to claim 1,
wherein the imaging object is a work object on which the work is performed by the tool, and
wherein, from a state in which the tool supporting the workpiece is located outside of the range, before performing the work on the work object by the tool, the driving mechanism is configured to move the tool supporting the workpiece such that at least part of the workpiece overlaps with the work object in the field of view of the imaging apparatus.

4. The end effector according to claim 1,
wherein, in a case of capturing the image of the imaging object by the imaging apparatus, the driving mechanism is configured to position the tool and the supported workpiece outside of the field of view of the imaging apparatus.

5. The end effector according to claim 1,
wherein the imaging object is a contact position at which the workpiece supported by the tool is brought into contact in the work.

6. The end effector according to claim 1,
wherein the tool includes a first finger portion and a second finger portion that are configured to hold and support the workpiece.

7. The end effector according to claim 6,
wherein the first finger portion includes a first base portion that is movably supported with respect to the base portion, and a first fingertip portion that is arranged further distal than the first base portion and is configured to hold the workpiece, and
wherein the second finger portion includes a second base portion that is movably supported with respect to the base portion, and a second fingertip portion that is arranged further distal than the second base portion and is configured to hold the workpiece, and

8. The end effector according to claim 7,
wherein the first finger portion and the second finger portion are formed such that, in a case of being moved with respect to the base portion by the driving mechanism, the first fingertip portion and the second fingertip portion are configured to move inside and outside of the range and, even in a case where the first fingertip portion and the second fingertip portion are located inside of the range, the first base portion and the second base portion are located outside of the range.

9. The end effector according to claim 7,
wherein, in a state of being located inside of the range, the first fingertip portion and the second fingertip portion are located between the imaging apparatus and a focal point of the imaging apparatus.

10. The end effector according to claim 7,
wherein the driving mechanism includes
a slide portion that is configured to support the first base portion and the second base portion in a slidingly movable manner,
a first drive unit that is configured to drive the first base portion to slidingly move in the slide portion, and
a second drive unit that is configured to be driven independently from the first drive unit and is configured to drive the second base portion to slidingly move in the slide portion.

11. A robot system comprising:
an end effector including a base portion, an imaging apparatus that is supported by the base portion and is configured to capture an image, and a tool that is movably supported by the base portion and is configured to perform work with respect to a workpiece;
a robot to which the end effector is attached, the robot being configured to move a position and posture of the end effector; and
a control unit configured to control the robot and the end effector,
wherein, in a case of capturing the image of an imaging object by the imaging apparatus, the control unit is configured to position the tool supporting the workpiece outside of a range in which at least part of the tool or the workpiece supported by the tool overlaps with the imaging object in a field of view of the imaging apparatus.

12. The robot system according to claim 11,
wherein the control unit is configured to perform alignment control to align the end effector with respect to the imaging object based on the image captured by the imaging apparatus.

13. The robot system according to claim 12,
wherein, as the alignment control, by calculating a misalignment amount between the end effector and the imaging object based on the image captured by the imaging apparatus and a target image that serves as a target, the control unit is configured to perform correction control to correct a position of the end effector to eliminate the misalignment amount.

14. The robot system according to claim 13,
wherein the imaging object includes a flat surface portion formed in a planar shape and an inclined portion inclined with respect to the flat surface portion,
wherein the end effector includes an irradiation unit irradiating light in an optical axis direction, and
wherein the control unit is configured to capture the image by the imaging apparatus in a manner irradiating the imaging object by the irradiation unit such that an optical axis of reflected light reflected at the flat surface portion is directed toward the imaging apparatus and an optical axis of reflected light reflected at the inclined portion is directed toward a direction away from the imaging apparatus.

15. The robot system according to claim 14,
wherein the imaging object includes a hole portion formed in a hole-like shape with respect to the flat surface portion, and
wherein the inclined portion is a chamfered portion chamfered at an outer edge of an opening of the hole portion.

16. The robot system according to claim 14,
wherein the imaging apparatus includes a telecentric optical system, and
wherein the control unit is configured to capture the image by the imaging apparatus in a state in which an optical axis of the telecentric optical system is maintained to be perpendicular to the flat surface portion.

17. The robot system according to claim 16,
wherein the irradiation unit is a coaxial incident illumination unit configured to irradiate the light coaxially with the optical axis of the telecentric optical system, and
wherein, while irradiating the flat surface portion by the coaxial incident illumination unit in a state in which the optical axis of the telecentric optical system is maintained to be perpendicular to the flat surface portion, the control unit is configured to capture the image by the imaging apparatus.

18. The robot system according to claim 13,
wherein the imaging object is a work position at which the tool performs the work with respect to the workpiece, and
wherein, in a case where there are a plurality of work positions, a same target image is used in the alignment control performed with respect to each of the plurality of work positions.

19. The robot system according to claim 18,
wherein the work performed at each of the plurality of work positions includes a first operation to cause the tool to support the workpiece that is located at at least one of the plurality of work positions, and a second operation to bring the workpiece supported by the tool into contact with at least one of the plurality of work positions, and
wherein the same target image is used in the alignment control performed before the first operation and the alignment control performed before the second operation.

20. The robot system according to claim 14,
wherein the control unit is configured to
calculate brightness of the light reflected at the flat surface portion from the image captured by the imaging apparatus while changing the posture of the end effector, and
perform posture correction control to correct the posture of the end effector such that the calculated brightness is maximized.

21. The robot system according to claim 14,
wherein the control unit is configured to
be connected to a teaching apparatus, that is configured to perform teaching by manipulating the posture of the end effector, and a display apparatus that is configured to display information, and,
in a case where the posture of the end effector has been changed, calculate brightness of the light reflected at the flat surface portion from the image captured by the imaging apparatus and display the brightness on the display apparatus.

22. A robot system comprising:
an end effector including an imaging apparatus and an irradiation unit configured to irradiate light in an optical axis direction;
a robot to which the end effector is attached, the robot being configured to move a position and posture of the end effector; and
a control unit configured to control the robot and the end effector,
wherein,
when performing alignment control to align the end effector with respect to an imaging object based on an image captured by the imaging apparatus,
the control unit is configured to capture the image of an imaging object, that includes a flat surface portion formed in a planar shape and an inclined portion inclined with respect to the flat surface portion, by the imaging apparatus in a manner irradiating by the irradiation unit such that an optical axis of reflected light reflected at the flat surface portion is directed toward the imaging apparatus and an optical axis of reflected light reflected at the inclined portion is directed toward a direction away from the imaging apparatus.

23. A control method of an end effector including a base portion, an imaging apparatus supported by the base portion, and a tool configured to perform work with respect to a workpiece, the method comprising:
a positioning step in which, in a case of capturing an image of an imaging object by the imaging apparatus, the control unit positions the tool supporting the workpiece outside of a range in which at least part of the tool or the workpiece supported by the tool overlaps with the imaging object in a field of view of the imaging apparatus.

24. A control method of a robot system including
an end effector including a base portion, an imaging apparatus supported by the base portion, and a tool configured to perform work with respect to a workpiece,
a robot to which the end effector is attached, the robot being configured to move a position and posture of the end effector, and
a control unit configured to control the robot and the end effector, the method comprising:
a positioning step in which, in a case of capturing an image of an imaging object by the imaging apparatus, the control unit positions the tool supporting the workpiece outside of a range in which at least part of the tool or the workpiece supported by the tool overlaps with the imaging object in a field of view of the imaging apparatus.

25. The control method of the robot system according to claim 24,
wherein, at the positioning step of positioning the tool, from a state in which at least part of the tool and the supported workpiece is located inside of the range, before capturing the image of the imaging object by the imaging apparatus, the control unit moves the tool supporting the workpiece outside of the range.

26. The control method of the robot system according to claim 24, further comprising:
an imaging step in which the control unit captures the image of the imaging object by the imaging apparatus in a state in which the tool supporting the workpiece is located outside of the range; and
a restoring step in which, after the imaging step,
from the state in which the tool supporting the workpiece is located outside of the range, before performing the work by the tool, the control unit moves the tool supporting the workpiece inside of the range such that at least part of the workpiece overlaps with the imaging object in the field of view of the imaging apparatus.

27. A control method of a robot system including
an end effector including an imaging apparatus configure to perform imaging and an irradiation unit configured to irradiate light in an optical axis direction,
a robot to which the end effector is attached, the robot being configured to move a position and posture of the end effector, and
a control unit configured to control the robot and the end effector, the method comprising:
an irradiating step in which the control unit irradiates an imaging object, that includes a flat surface portion formed in a planar shape and an inclined portion inclined with respect to the flat surface portion, by the irradiation unit such that an optical axis of reflected light reflected at the flat surface portion is directed toward the imaging apparatus and an optical axis of reflected light reflected at the inclined portion is directed toward a direction away from the imaging apparatus;
an imaging step in which the control unit captures the image of the imaging object, that is irradiated with the light at the irradiating step, by the imaging apparatus; and
a calculating step in which the control unit calculates a positional relationship between the end effector and the imaging object from the image captured by the imaging apparatus.

28. A method for manufacturing an article by using the robot system according to claim 11.

29. A non-transitory computer readable medium storing a program that enables a computer to execute the control method of the robot system according to claim 24.
